(19) United States
(12) Patent Application Publication
(10) Pub. No.: US 2026/0087801 A1
(43) Pub. Date: Mar. 26, 2026

(54) METHODS FOR CONVERSATIONAL INTERACTIONS WITH AN ARTIFICIALLY INTELLIGENT ASSISTANT, AND SYSTEMS OF USE THEREOF

(71) Applicant: Meta Platforms Technologies, LLC, Menlo Park, CA (US)

(72) Inventors: Willy Huang, San Francisco, CA (US); Nancy Oh, San Mateo, CA (US); Nicholas Pelczar, Tucson, AZ (US); Katy Boungard, Seattle, WA (US); Lauren Foley, Seattle, WA (US); Leif Haven Martinson, Oakland, CA (US); Jessica Kitchens, Seattle, WA (US); Kay Niu, San Francisco, CA (US)

(21) Appl. No.: 19/336,433

(22) Filed: Sep. 22, 2025

Related U.S. Application Data
(60) Provisional application No. 63/699,117, filed on Sep. 25, 2024.
(60) Provisional application No. 63/782,535, filed on Apr. 2, 2025.

(51) Int. Cl. G06V 20/20; G06F 3/01; G06F 3/16; G06F 9/451

(52) U.S. Cl. CPC G06V 20/20; G06F 3/017; G06F 3/167; G06F 9/453

(57) ABSTRACT

A method for conversational interactions with an artificially intelligent (AI) assistant at a pair of smart glasses is described. The method includes, invoking an AI assistant at the pair of smart glasses without providing a query, wherein the artificially intelligent assistant has access to camera data provided by a camera of the pair of smart glasses. The method further includes, in response to invoking the artificially intelligent assistant at the pair of smart glasses, (i) determining, based in part on the camera data, that the AI assistant should provide assistance to a user related to an object present within the camera data, and (ii) in response to the determining, providing, via an output modality of the pair of smart glasses, a communication to the user that includes the assistance to the user related to the object present within the camera data.

### RELATED APPLICATIONS

This application claims priority to U.S. Provisional Ser. No. 63/699,117, entitled “Methods For Conversational Interactions With An Artificially Intelligent Assistant, And Systems Of Use Thereof” filed Sep. 25, 2024, and U.S. Provisional Ser. No. 63/782,535, entitled “Methods For Conversational Interactions With An Artificially Intelligent Assistant, And Systems Of Use Thereof” filed Apr. 2, 2025, which are hereby incorporated by reference in their entirety.

### TECHNICAL FIELD

This relates generally to methods for conversational interactions between a user and an artificially intelligent (AI) assistant at a head-wearable device.

### BACKGROUND

Communications with current artificially intelligent (AI) assistants are not natural enough, (i.e., it is not possible to have an ongoing natural conversation with the AI assistant). Current AI assistants require that queries receive full responses before the user can provide another query, even if the full response is incorrect, which makes conversations longer and frustrating. Current AI assistants also will remain idle while processing a response to a communication from a user, which creates awkward pauses in the conversation. Additionally, after finishing a conversation with a current AI assistant, the user may forget to deactivate the AI assistant and cause the AI assistant to continue using limited battery supplies.

As such, there is a need to address one or more of the above-identified challenges. A brief summary of solutions to the issues noted above are described below.

### SUMMARY

An example method for conversational interactions with an artificially intelligent (AI) assistant at a pair of smart glasses is described herein. The method includes, invoking an AI assistant at the pair of smart glasses without providing a query, wherein the artificially intelligent assistant has access to camera data provided by a camera of the pair of smart glasses. The method further includes, in response to invoking the artificially intelligent assistant at the pair of smart glasses, (i) determining, based in part on the camera data, that the AI assistant should provide assistance to a user related to an object present within the camera data, and (ii) in response to the determining, providing, via an output modality of the pair of smart glasses, a communication to the user that includes the assistance to the user related to the object present within the camera data.

A second example method for conversational interactions with an AI assistant at a pair of smart glasses is now described. The method includes, invoking an AI assistant at the pair of smart glasses, the pair of smart glasses including an indicator light that is configured to notify a user regarding a status of the AI assistant. The method further includes, in response to invoking the AI assistant, providing a first light output of the indicator light signifying that an active session with the AI assistant has been invoked. The method further includes, while the active session with the AI assistant is ongoing: (i) in accordance with a determination that the user is providing a communication to the AI assistant, providing a second light output of the indicator light signifying that the AI assistant is listening to the communication and, (ii) in accordance with a determination that the user has completed communicating with the AI assistant, providing a third light output of the indicator light signifying that the communication is at least being processed by the AI assistant.

A third example method for conversational interactions with an AI assistant at a pair of smart glasses is now described. The method includes, in response to receiving a communication from a user wearing the pair of smart glasses, outputting, via an audio output component of the pair of smart glasses, a response to the communication from the user. The method further includes, while providing the response to the communication from the user, receiving an additional communication from the user that occurs before the response to the communication has been completed. The method further includes, in response to receiving the additional communication and while the additional communication is still being received: (i) ceasing providing the response and providing an acknowledgement, via the audio output component of the pair of smart glasses, that the additional communication has been received. The method further includes, providing an updated response after receiving the additional communication to the user.

A fourth example method for conversational interactions with an AI assistant at a pair of smart glasses is now described. The method includes, in response to receiving a communication from a user wearing a pair of smart glasses: (i) outputting, via an audio output component of the pair of smart glasses, an intermediary response prepared by the AI assistant, wherein the intermediary response occurs while the AI assistant is processing a full to the communication and the intermediary response has a first processing time, and, (ii) after outputting the intermediary response, outputting the full response to the communication from the user, wherein the full response has a second processing time that is greater than the first processing time.

A fifth example method for generating an archive of a session with an artificially intelligent assistant at a pair of smart glasses is now described. The method includes invoking a session with an artificially intelligent assistant at a pair of smart glasses, wherein the artificially intelligent assistant has access to camera data captured at a camera of the pair of smart glasses. The method further includes in response to invoking the artificially intelligent assistant at the pair of smart glasses: (i) receiving one or more inputs from a user, the one or more inputs directed at the artificially intelligent assistant, (ii) capturing one or more images at the camera of the pair of smart glasses, and (iii) presenting one or more responses to the user, the one or more responses to the user generated by the artificially intelligent assistant. The method further includes, in response to a termination of the session with the artificially intelligent assistant, generating an archive of the session, the archive of the session including one or more of: (i) the one or more inputs from the user, (ii) the one or more images, and (iii) the one or more responses to the user.

A sixth example method for presenting an archive of a session with an artificially intelligent assistant at a pair of smart glasses is now described. The method includes, receiving, at a device communicatively coupled to a pair of smart glasses, a session information set associated with a session with an artificially intelligent assistant at the pair of smart glasses, wherein the session information set includes one or more inputs from a user, one or more images, and/or one or more responses to the user. The method further includes presenting a session menu UI including a session summary UI element, wherein the session summary UI element includes at least one of the one or more inputs from the user, at least one of the one or more images, and/or at least one of the one or more responses to the user. The method further includes, in response to a request to view the session information set, presenting a session archive UI including the one or more inputs from the user, the one or more images, and/or the one or more responses to the user in a chronological order.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset (e.g., a mixed-reality (MR) headset or an augmented-reality (AR) headset as two examples), a wrist-wearable device, an intermediary processing device, a smart textile-based garment, etc. For instance, the instructions can be stored on an AR headset or can be stored on a combination of an AR headset and an associated input device (e.g., a wrist-wearable device) such that instructions for causing detection of input operations can be performed at the input device and instructions for causing changes to a displayed user interface in response to those input operations can be performed at the AR headset. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1B illustrate examples of a user invoking an artificial-intelligence (AI) assistant session at a head-wearable device, in accordance with some embodiments.

FIGS. 2A-2D illustrate examples of an AI assistant presenting a conversational acknowledgement of a user barge-in to a user of a head-wearable device, in accordance with some embodiments.

FIG. 3 illustrates an AI assistant presenting example check-in phrases to a user of a head-wearable device, in accordance with some embodiments.

FIGS. 4A-4B illustrate examples of an AI assistant presenting, in response to a user command, an intermediary response and a full response to a user of a head-wearable device, in accordance with some embodiments.

FIGS. 5A-5B illustrate examples of an AI assistant presenting a confirmation cue to a user of a head-wearable device, in accordance with some embodiments.

FIGS. 6A-6B illustrate a light indication provided to a user of a head-wearable device during an AI assistant session, in accordance with some embodiments.

FIGS. 7A, 7B-1, and 7B-2 illustrate a user of a head-wearable device interacting with an AI assistant throughout an extended AI assistant session, in accordance with some embodiments.

FIGS. 8A-8B illustrate a user interfaces (UIs) associated with one or more extended AI assistant sessions, in accordance with some embodiments.

FIG. 9 illustrates an example of a user setting interface for assigning user settings that are applied to an AI assistant and AI assistant sessions, in accordance with some embodiments.

FIGS. 10A-10F illustrate example method flow charts for interaction between and a user of a head-wearable device and an AI assistant, in accordance with some embodiments.

FIGS. 11A, 11B, 11C-1, and 11C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR headset. Throughout this application, the term “extended reality (XR)” is used as a catchall term to cover both ARs and MRs. In addition, this application also uses, at times, a head-wearable device or headset device as a catchall term that covers XR headsets such as AR headsets and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single-or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

A gaze gesture, as described herein, can include an eye movement and/or a head movement indicative of a location of a gaze of the user, an implied location of the gaze of the user, and/or an approximated location of the gaze of the user, in the surrounding environment, the virtual environment, and/or the displayed user interface. The gaze gesture can be detected and determined based on (i) eye movements captured by one or more eye-tracking cameras (e.g., one or more cameras positioned to capture image data of one or both eyes of the user) and/or (ii) a combination of a head orientation of the user (e.g., based on head and/or body movements) and image data from a point-of-view camera (e.g., a forward-facing camera of the head-wearable device). The head orientation is determined based on IMU data captured by an IMU sensor of the head-wearable device. In some embodiments, the IMU data indicates a pitch angle (e.g., the user nodding their head up-and-down) and a yaw angle (e.g., the user shaking their head side-to-side). The head-orientation can then be mapped onto the image data captured from the point-of-view camera to determine the gaze gesture. For example, a quadrant of the image data that the user is looking at can be determined based on whether the pitch angle and the yaw angle are negative or positive (e.g., a positive pitch angle and a positive yaw angle indicate that the gaze gesture is directed toward a top-left quadrant of the image data, a negative pitch angle and a negative yaw angle indicate that the gaze gesture is directed toward a bottom-right quadrant of the image data, etc.). In some embodiments, the IMU data and the image data used to determine the gaze are captured at a same time, and/or the IMU data and the image data used to determine the gaze are captured at offset times (e.g., the IMU data is captured at a predetermined time (e.g., 0.01 seconds to 0.5 seconds) after the image data is captured). In some embodiments, the head-wearable device includes a hardware clock to synchronize the capture of the IMU data and the image data. In some embodiments, object segmentation and/or image detection methods are applied to the quadrant of the image data that the user is looking at.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Interactions With an Artificially Intelligent Assistant at a Pair of Smart Glasses

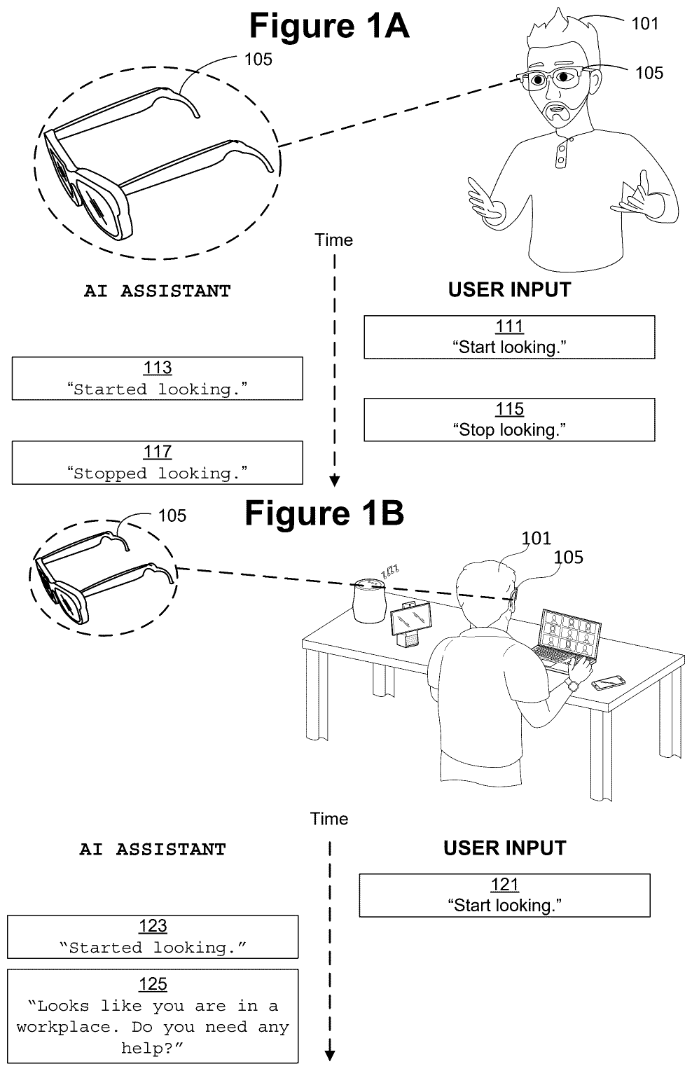

FIGS. 1A-1B illustrate examples of a user 101 invoking an artificial-intelligence (AI) assistant session at a head-wearable device 105, in accordance with some embodiments. The AI assistant is executed at a processing device of the head-wearable device 105 (e.g., a pair of smart glasses and/or a pair of extended-reality (XR) glasses) and/or another processing device communicatively coupled to the head-wearable device 105 (e.g., a server, a smartphone, a handheld intermediary processing device, and/or a computer). In some embodiments, the user 101 invokes the AI assistant by performing an invocation voice command (e.g., a wake word and/or a wake phrase such as “Hey Assistant,” and/or “Start looking” detected as a microphone of the head-wearable device 105), an invocation hand gesture (e.g., a middle finger pinch gesture), an invocation touch input command (e.g., tapping a temple arm of the head-wearable device 105 and/or a button press at a communicatively coupled device, such as the smartphone), and/or an open-ended query directed at the AI assistant (e.g., “What's the weather today?” and/or “Tell me my shopping list”). In some embodiments, the open-ended query is determined to be directed at the AI assistant by on a machine-learning algorithm and is based on user behavior, user settings, previous commands, a predictive intent of the user 101, additional sensor data, and/or other contextual factors (e.g., location, time of day, type of voice command, etc.). In some embodiments, the AI assistant can only be invoked while the user 101 is wearing the head-wearable device 105.

FIG. 1A illustrates the user 101 invoking and terminating a first AI assistant session while wearing the head-wearable device 105, in accordance with some embodiments. The user 101 invokes the first AI assistant session by performing a first invocation command 111 (e.g., an invocation voice command “Start looking.”). In response to the first invocation command 111, the AI assistant presents a first invocation confirmation 113 to the user 101. In some embodiments, the first invocation confirmation 113 is an invocation confirmation message (e.g., a message “Started looking.” is presented at a speaker of the head-wearable device 105), an audio cue (e.g., a beep and/or a tone), and/or a light cue (e.g., an LED of the head-wearable device turns on, changes brightness, changes color, and/or pulsates). The user 105 terminates the first AI assistant session by performing a first termination command 115 (e.g., a first termination voice command “Stop looking.”). In response to the first termination command 115, the AI assistant presents a first termination confirmation 117 to the user 101 (e.g., a message, such as “Stopped looking,” is presented at a speaker of the head-wearable device 105).

FIG. 1B illustrates the user 101 invoking a second AI assistant session while wearing the head-wearable device 105, in accordance with some embodiments. The user 105 invokes the second AI assistant session by performing a second invocation command 121 (e.g., the invocation voice command “Start looking.”). In response to the second invocation command 121, the AI assistant presents a second invocation confirmation 123 to the user 101 (e.g., the message “Started looking.” is presented at the speaker of the head-wearable device 105). In some embodiments, the first invocation command 111 additionally causes the AI assistant to determine one or more first objects in first image data (e.g., an image and/or a video representing a field-of-view of the user 101) at an imaging device (e.g., a forward-facing camera) of the head-wearable device 105. In some embodiments, the one or more first objects are determined using a machine-learning model (e.g., a large language model (LLM) and/or a multimodal model). In some embodiments, the determination of the one or more first objects is further based on user behavior, user settings, previous commands, a predictive intent of the user 101, additional sensor data, and/or other contextual factors. In response to the second invocation command 121, the AI assistant determines the one or more first objects in the first image data. Based on the one or more first objects in the image data, the AI assistant prepares a comment on the first image data 125 (e.g., “Looks like you are in a workplace. Do you need any help?”) and presents the comment on the first image data 125 to the user 101). In some embodiments, the comment on first the image data 125 suggests and/or hints at a function that can be performed by the AI assistant (e.g., “Looks like you are in a workplace. Would you like to see work calendar for today?”). In some embodiments, the comment on the first image data 125 is further based on a previous AI assistant session and/or a previous command made before the AI assistant determined the one or more first objects in the first image data. In some embodiments, the comment on the first image data 125 includes an XR augment presented at a display of the head-wearable device 105.

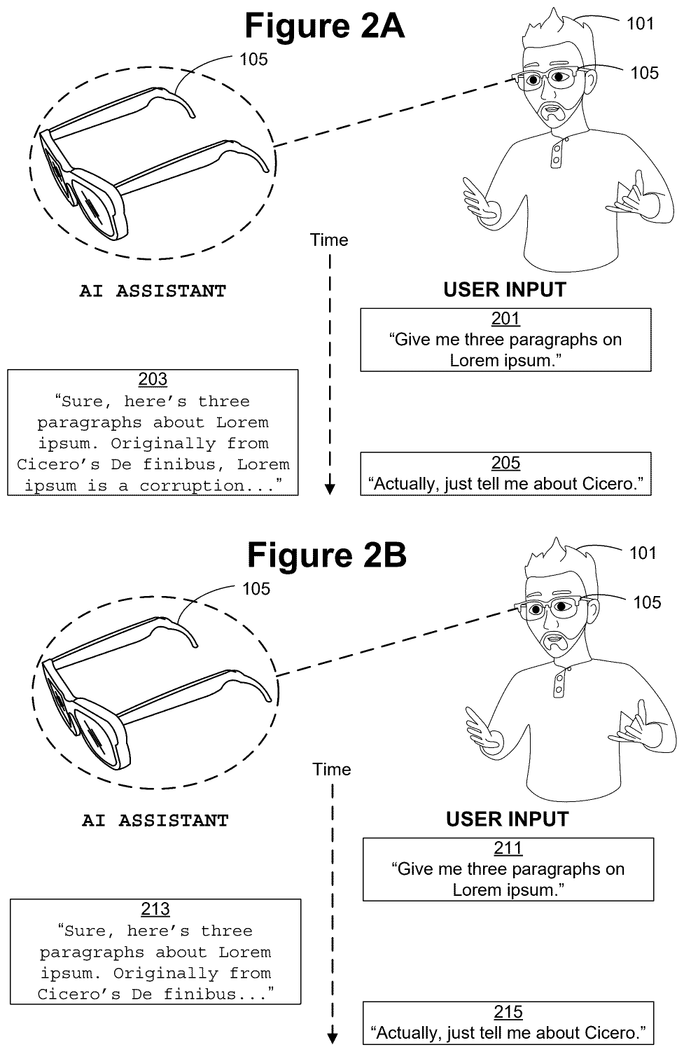

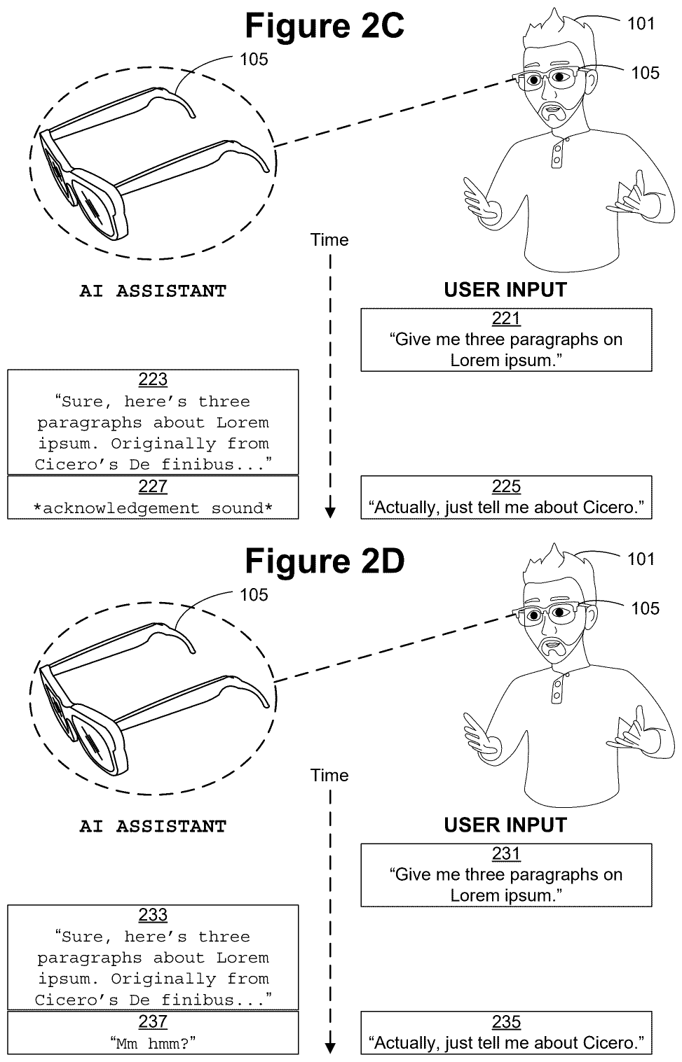

FIGS. 2A-2D illustrate examples of the AI assistant presenting a conversational acknowledgement of a user barge-in (e.g., a user interrupting an AI assistant response), in accordance with some embodiments. The user barge-in occurs when the user 101 performs an additional communication (e.g., a follow-up command) while the AI assistant is presenting a response to an initial command (e.g., at the speaker of the head-wearable device 105). While FIGS. 2A-2D illustrate the user barge-in as voice commands, the user barge-in can also be a touch input and/or a hand gesture. In some embodiments, the user barge-in includes a request to cease presenting the response to the initial command (e.g., “Okay, that's enough.”). In some embodiments, the user barge-in includes a follow-up command (e.g., “Actually, just tell me about Cicero.” as illustrated in FIGS. 2A-2D), and the AI assistant prepares a follow-up response (e.g., “Okay, Cicero was a Roman orator...”) based on the follow-up command and/or initial command. In some embodiments, the user barge-in includes a correction to a misinterpretation provided in the response to the initial command, and the follow-up response takes into account the correction to the misinterpretation. In some embodiments, the follow-up response is distinct from a remainder of the response to the initial command. In some embodiments, the response to the initial command and/or the follow-up response includes another XR augment presented at the display of the head-wearable device 105.

FIG. 2A illustrates the AI assistant reacting to a first user barge-in 205 while the user 101 is wearing the head-wearable device 105, in accordance with some embodiments. The user 101 performs a first initial command 201 (e.g., “Give me three paragraphs on Lorem ipsum.”), and the AI assistant prepares a first response 203 (e.g., “Sure, here's three paragraphs about Lorem ipsum. Originally from Cicero's De finibus, Lorem ipsum is a corruption of the thirty-second and thirty-third paragraphs . . . ”) based on the first initial command 201. While the AI assistant is presenting the first response 203 at the head-wearable device 105, the user 101 performs a first user barge-in 205 (e.g., “Actually, just tell me about Cicero.”). In response to the first user barge-in 205, the AI assistant ceases presenting the first response 203 once the user 101 has finished performing the first user barge-in 205 (e.g., the AI assistant continues presenting the first response 203 (“ . . . Lorem ipsum is a corruption . . . ”) while the user 101 is performing the first user barge-in 205 (“Actually, just tell me about Cicero.”), and the AI assistant stops presenting the first response 203 only when the user 101 has finished performing the first user barge-in 205).

FIG. 2B illustrates the AI assistant reacting to a second user barge-in 215 while the user 101 is wearing the head-wearable device 105, in accordance with some embodiments. The user 101 performs a second initial command 211, and the AI assistant prepares a second response 213 based on the second initial command 211. While the AI assistant is presenting the second response 213 at the head-wearable device 105, the user 101 performs a second user barge-in 215. In response to the second user barge-in 215, the AI assistant ceases presenting the second response 213 when the user 101 starts performing the second user barge-in 215 (e.g., the second response 213 gets cut off at “Sure, here's three paragraphs about Lorem ipsum. Originally from Cicero's De finibus . . . ”when the user 101 starts performing the second user barge-in 215).

FIG. 2C illustrates the AI assistant reacting to a third user barge-in 225 while the user 101 is wearing the head-wearable device 105, in accordance with some embodiments. The user 101 performs a third initial command 221, and the AI assistant prepares a third response 223 based on the third initial command. While the AI assistant is presenting the third response 223 at the head-wearable device 105, the user 101 performs a third user barge-in 225. In response to the third user barge-in 225, the AI assistant ceases presenting the third response 223 when the user 101 starts performing the third user barge-in 225. Additionally, in response to the third user barge-in 225, the AI assistant presents an acknowledgement sound 227 (e.g., a tone, chirp, and/or another non-verbal audio cue presented at the speaker of the head-wearable device 105). The acknowledgement sound 227 indicates to the user 101 that the AI assistant is listening to the third user barge-in 225. In some embodiments, the acknowledgement sound 227 is presented immediately after the AI assistant ceases presenting the third response 223 (e.g., while the user 101 is still performing the third user barge-in 225) and/or after the user 101 has completed performing the third user barge-in 225 (e.g., the AI assistant waits until the user 101 has stopped talking to present the acknowledgement sound 227).

FIG. 2D illustrates the AI assistant reacting to a fourth user barge-in 235 while the user 101 is wearing the head-wearable device 105, in accordance with some embodiments. The user 101 performs a fourth initial command 231, and the AI assistant prepares a fourth response 223 based on the fourth initial command 231. While the AI assistant is presenting the fourth response 233 at the head-wearable device 105, the user 101 performs a fourth user barge-in 235. In response to the fourth user barge-in 235, the AI assistant ceases presenting the fourth response 233 when the user 101 starts performing the fourth user barge-in 235. Additionally, in response to the fourth user barge-in 235, the AI assistant presents an acknowledgement phrase 237 (e.g., “Mm hmm?”, “Go ahead.” and/or “Yeah?”). The acknowledgement phrase 237 indicates to the user 101 that the AI assistant is listening to the fourth user barge-in 235. In some embodiments, the acknowledgement phrase 237 is presented immediately after the AI assistant ceases presenting the fourth response 233 (e.g., while the user 101 is still performing the fourth user barge-in 235) and/or after the user 101 has completed performing the fourth user barge-in 235 (e.g., the AI assistant waits until the user 101 has stopped talking to present the acknowledgement phrase 237). In some embodiments, the acknowledgement phrase 237 is based on the fourth response 233.

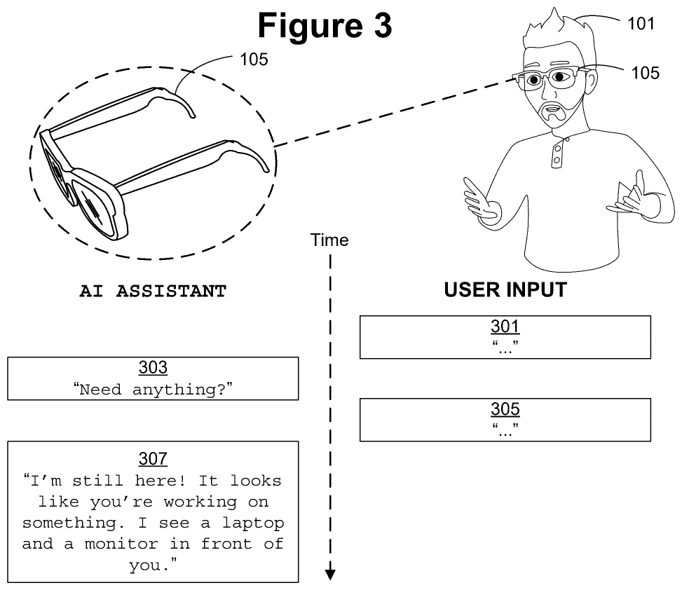

FIG. 3 illustrates the AI assistant presenting example check-in phrases while the user 101 is wearing the head-wearable device 105, in accordance with some embodiments. In some situations, the user 101 may begin an AI assistant session at the head-wearable device 105, interact with the AI assistant, and forget to end the AI assistant session when done. The user 101 may not want to end the AI assistant session while not interacting with the AI assistant as leaving the AI assistant session running may drain a battery life of the head-wearable device 105. Additionally, the user 101 may not want to end the AI assistant session while not interacting with the AI assistant as the imaging device of the head-wearable 105 continues to capture image data during the AI assistant session which may lead to privacy issues. In some embodiments, after a first period of time 301 where the user 101 has not interacted with the AI assistant, the AI assistant presents a first check-in phrase 303 (e.g., “Need anything? ”) at the speaker of the head-wearable device 105. In some embodiments, after a second period of time 305 where the user 101 has not interacted with the AI assistant, the AI assistant presents a second check-in phrase 307 (e.g., “I'm still here! It looks like you're working on something. I see a laptop and a monitor in front of you.”) at the speaker of the head-wearable device 105. In some embodiments, the second check-in phrase 307 is based on one or more second objects determined by the AI assistant from second image data captured by the imaging device of the head-wearable device 105, previous commands from the user 101, user settings, a predicted intent of the user 101, additional sensor data, and/or other contextual factors.

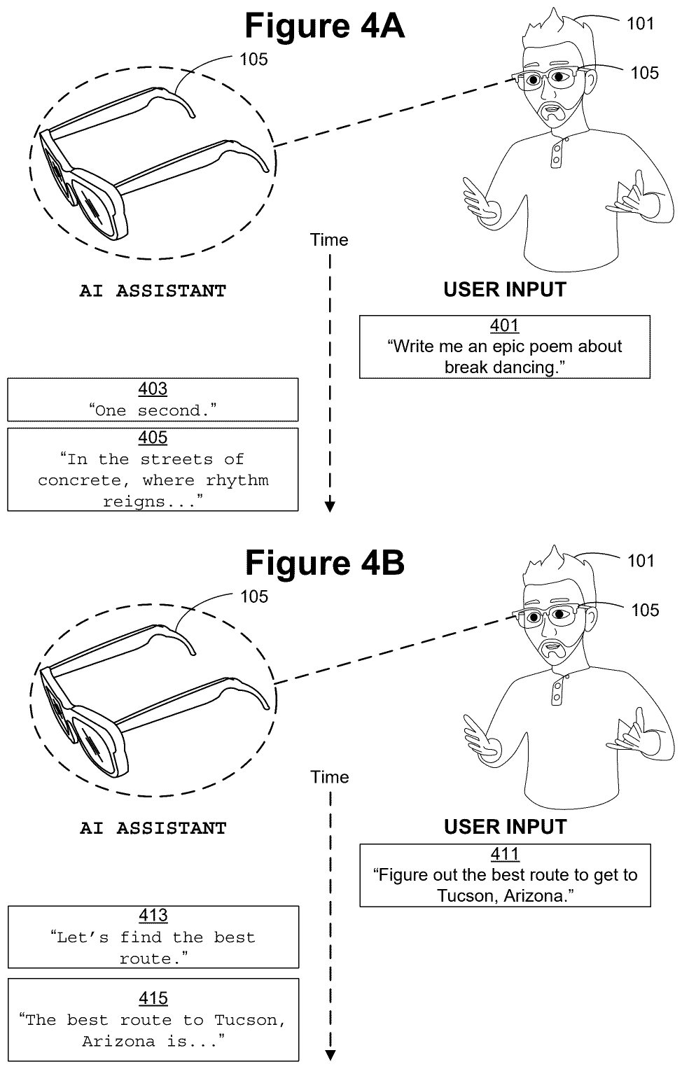

FIGS. 4A-4B illustrate examples of the AI assistant presenting an intermediary response and a full response in response to a user command, in accordance with some embodiments. In some embodiments, the intermediary response has a first processing time, and the full response has a second processing time, longer that the first processing time. Therefore, the intermediary response reduces a user-perceived latency period between a time when the user 101 makes the user command and when the AI assistant presents the full response to the user command (e.g., the AI assistant presents the intermediary response while it is processing the user command and/or preparing the full response to the user command). While FIGS. 4A-4B illustrate the intermediary response as a natural language response, the intermediary response may also be a non-verbal audio cue (e.g., a tone and/or a click). In some embodiments, the intermediary response is prepared by a first LLM and the full response is prepared by a second LLM that is different than the first LLM. In some embodiments, the intermediary response and/or the full response is based on the user command, one or more other objects determined by the AI assistant from other image data captured by the imaging device of the head-wearable device 105, previous commands from the user 101, user settings, a predicted intent of the user 101, additional sensor data, and/or other contextual factors.

In some embodiments, the intermediary response confirms receipt of the user command by the AI assistant and allows the user 101 to perform the user barge-in (e.g., as described in reference to FIGS. 2A-2D) before the AI assistant has begun presenting the full response to the user command (e.g., if the AI assistant mishears and/or misunderstands the user command, the user 101 is able to understand, based on the intermediary response, that the AI assistant has misheard and/or misunderstood the user command, and the user 101 may perform the user barge-in to correct the AI assistant before the AI assistant provides the full response to the user command). In some embodiments, in response to the user barge-in, the AI assistant presents another intermediary response, based on the user barge-in. In response to the user barge-in, the AI assistant presents the full response, based on the user barge-in and/or the user command.

FIG. 4A illustrates the AI assistant presenting a first intermediary response 403 in response to a first user command 401. The user 101 provides the first user command 401 (e.g., “Write me an epic poem about break dancing.”) that is detected at the microphone of the head-wearable device 105. In response to detecting the first user command 401, the AI assistant presents the first intermediary response 403 (e.g., “One second. ”) at the speaker of the head-wearable device. After providing the first intermediary response 403, the AI assistant provides a first full response 405 (e.g., “In the streets of concrete, where rhythm reigns . . . ”).

FIG. 4B illustrates the AI assistant presenting a second intermediary response 413 in response to a second user command 411. The user 101 provides the second user command 411 (e.g., “Figure out the best route to get to Tucson, Arizona.”) that is detected at the microphone of the head-wearable device 105. In response to detecting the second user command 411, the AI assistant presents the second intermediary response 413 (e.g., “Let's find the best route.”) at the speaker of the head-wearable device. In some embodiments, the second intermediary response 413 is based, at least in part, on the second user command 411, as illustrated in FIG. 4B. After providing the second intermediary response 413, the AI assistant provides a second full response 415 (e.g., “The best route to Tucson, Arizona is . . . ”).

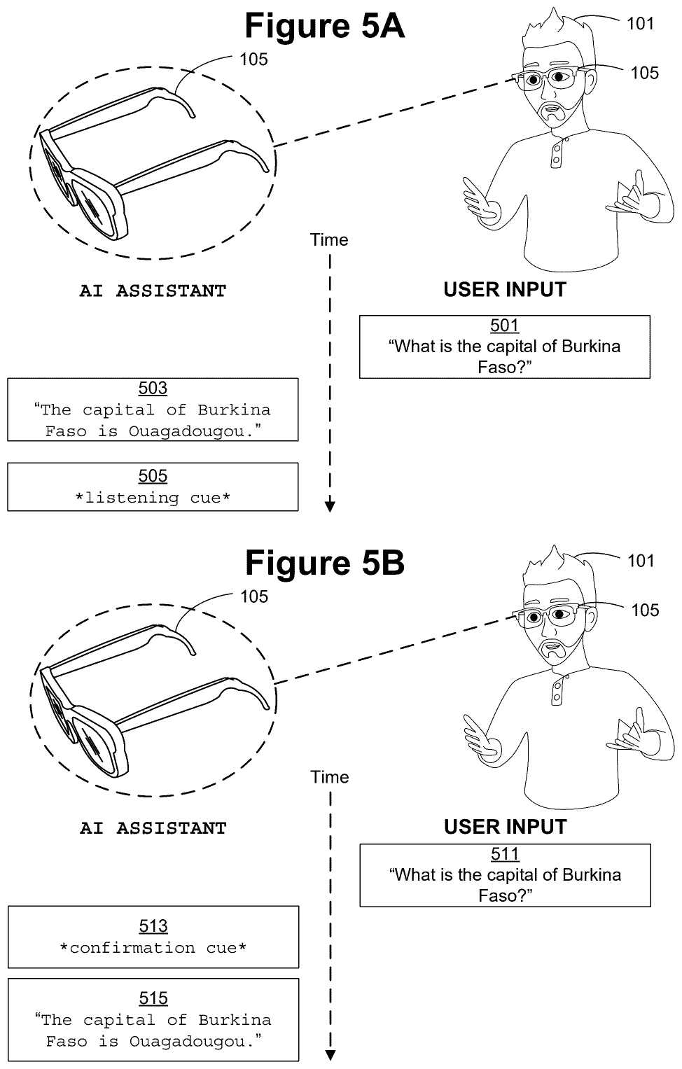

FIGS. 5A-5B illustrate examples of the AI assistant presenting a confirmation cue to the user 101, in accordance with some embodiments. In some embodiments, the confirmation cue is a confirmation message (e.g., a message “Listening. ” and/or “Heard you.” is presented at a speaker of the head-wearable device 105), an audio cue (e.g., a beep and/or a tone), and/or a light cue (e.g., an LED of the head-wearable device turns on, changes brightness, changes color, and/or pulsates). In some embodiments, the confirmation cue is presented in response to another user command, and the confirmation cue and/or a response to the other command is based on the other user command.

FIG. 5A illustrates the AI assistant presenting a listening confirmation cue 505, in accordance with some embodiments. The user 101 provides a third user command 501 (e.g., “What is the capital of Burkina Faso?”), and, in response to the third user command 501, the AI assistant presents a third response 503 (e.g., “The capital of Burkina Faso is Ouagadougou.”) at the speaker of the head-wearable device 105. After presenting the third response 503, the AI assistant presents the listening confirmation cue 505 (e.g., an audio cue) to indicate to the user 101 that the AI assistant is listening to the user 101 for any other commands and/or communications.

FIG. 5B illustrates the AI assistant presenting a received confirmation cue to the user 101, in accordance with some embodiments. The user 101 provides a fourth user command 511 (e.g., “What is the capital of Burkina Faso?”), and, in response to the fourth user command 511, the AI assistant presents a received confirmation cue 513 (e.g., another audio cue, distinct from the audio cue) to indicate to the user 101 that the AI assistant heard the fourth user command 511 at the speaker of the head-wearable device 105. After presenting the received confirmation cue 513, the AI assistant presents a fourth response 515 (e.g., “The capital of Burkina Faso is Ouagadougou.”).

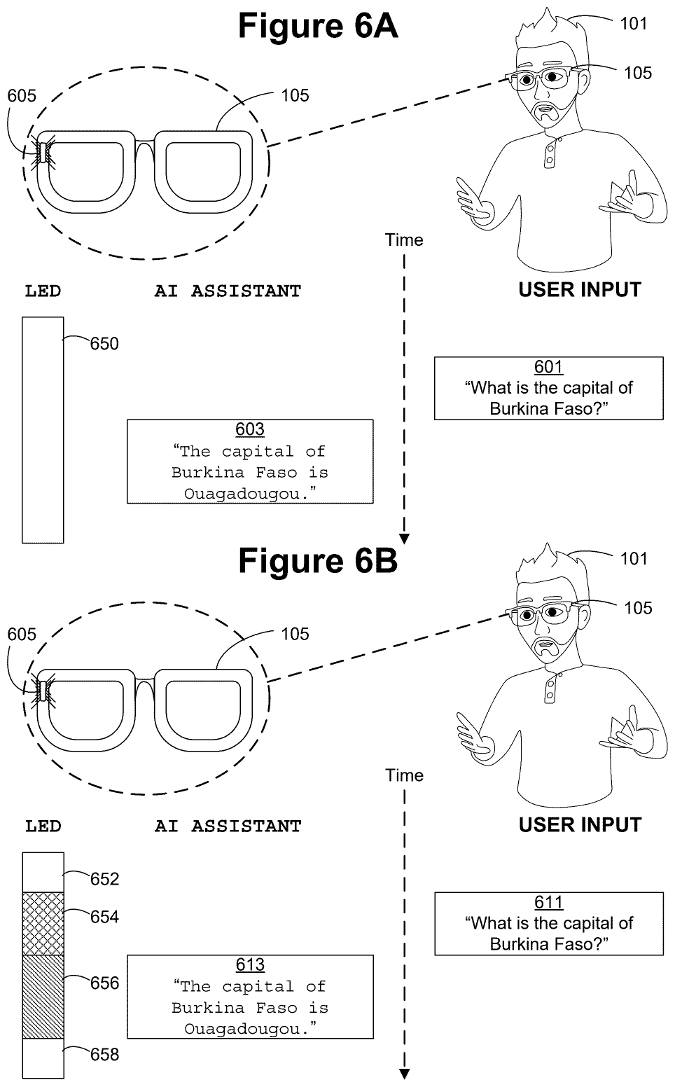

FIGS. 6A-6B illustrate a light indication provided to the user 101 during an AI assistant session, in accordance with some embodiments. The light indication is on during the AI assistant session and/or while the imaging device of the head-wearable device 105 is capturing image data, and is the light indication is off when there is not active AI assistant session and/or the imaging device of the head-wearable device 105 is not capturing image data. In some embodiments, the light indication is provided at an indicator light 605 (e.g., an LED) of the head-wearable device 105. In some embodiments, the indicator light 605 is configured to be visible to the user 101 (e.g., in a peripheral view of the user 101) as well as other people nearby the user 101 (e.g., in a frame portion of the head-wearable device 105, such as at a nose bridge or at a corner of the lens frame where a temple arm attaches to the frame, as illustrated in FIGS. 6A-6B). The indicator light 605 indicates that the AI assistant session is active and the imaging device of the head-wearable device is capturing image data to both the user 101 and the people nearby the user 101. In some embodiments, an additional XR augment is presented at a display of the head-wearable device 105 to indicate to the user 101 that the AI assistant session is active and the imaging device of the head-wearable device is capturing image data. In some embodiments, the indicator light 605 is configured to provide additional notifications (e.g., a received text message) and/or additional status of the head-wearable device 105 (e.g., a low battery level) to the user 101.

FIG. 6A illustrates a first light indication provided to the user 101 during a first AI assistant session, in accordance with some embodiments. During the first AI assistant session, the user 101 provides a fifth user command 601 (e.g., “What is the capital of Burkina Faso?”), and the AI assistant presents a fifth response 603 (e.g., “The capital of Burkina Faso is Ouagadougou.”). Throughout the first AI assistant session (including before the user 101 provides the fifth user command 601 and after the AI assistant presents the fifth response 603, as the AI assistant session is still active), the indicator light 605 presents a first light output 650 (e.g., a solid white light) to indicate that the first AI assistant session is active. In some embodiments, once the first AI assistant session is terminated, the indicator light 605 turns off.

FIG. 6B illustrates a second light indication provided to the user 101 during a second AI assistant session, in accordance with some embodiments. During the second AI assistant session, the user 101 provides a sixth user command 611 (e.g., “What is the capital of Burkina Faso?”), and the AI assistant presents a sixth response 613 (e.g., “The capital of Burkina Faso is Ouagadougou.”). During the second AI assistant session and before the user 101 provides the sixth user command 611, the indicator light 605 presents a second light output 652 (e.g., a solid white light) to indicate that the second AI assistant session is active. While the user 101 provides the sixth user command 611, the indicator light 605 presents a third light output 654 (e.g., distinct from the second light output 652 in luminosity, pattern, and/or color, such as a dim pulsing light) to indicate that the AI assistant is listening to the sixth user command 611. While the AI assistant presents the sixth response 613, the indicator light 605 presents a the (e.g., distinct from the second light output 652 and the third light output 654 in luminosity, pattern, and/or color, such as a bright pulsing light) to indicate that the AI assistant is processing the sixth user command 611 and/or the AI assistant is presenting the sixth response 613. During the second AI assistant session and after the AI assistant presents the sixth response 613, the indicator light 605 presents a fifth light output 658 (e.g., a solid white light) to indicate that the second AI assistant session is active.

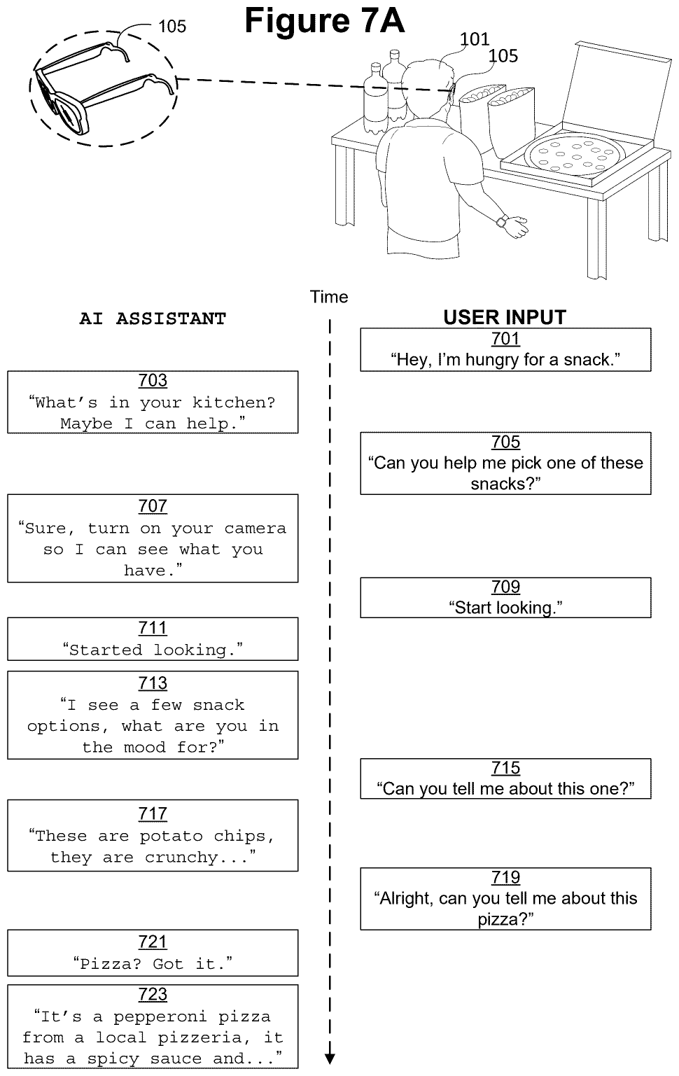

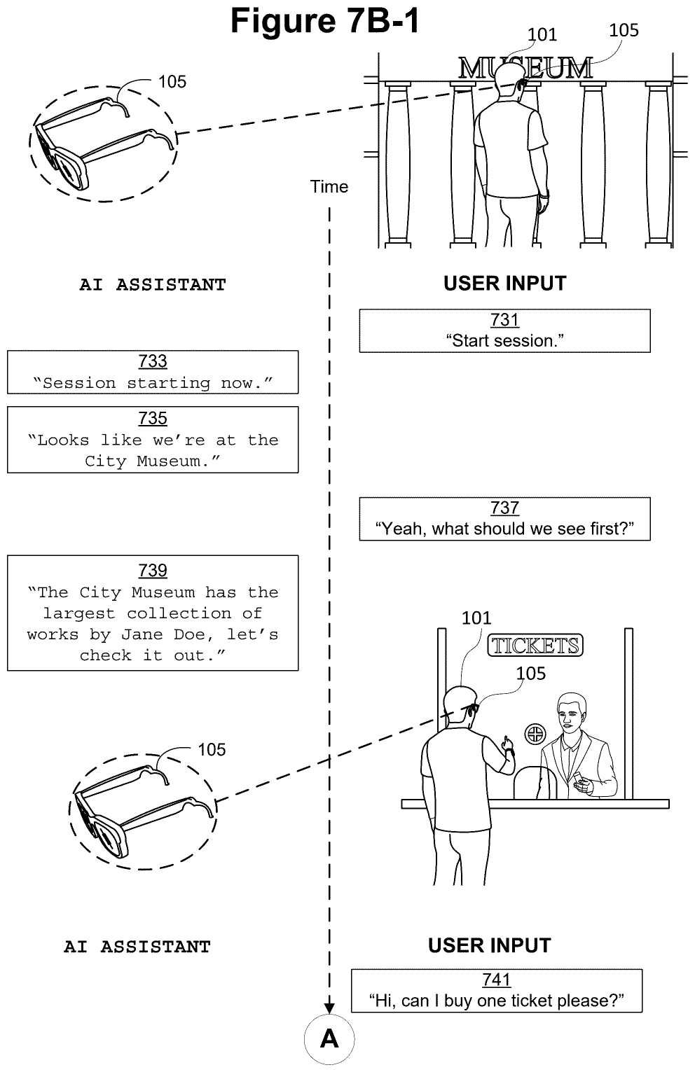

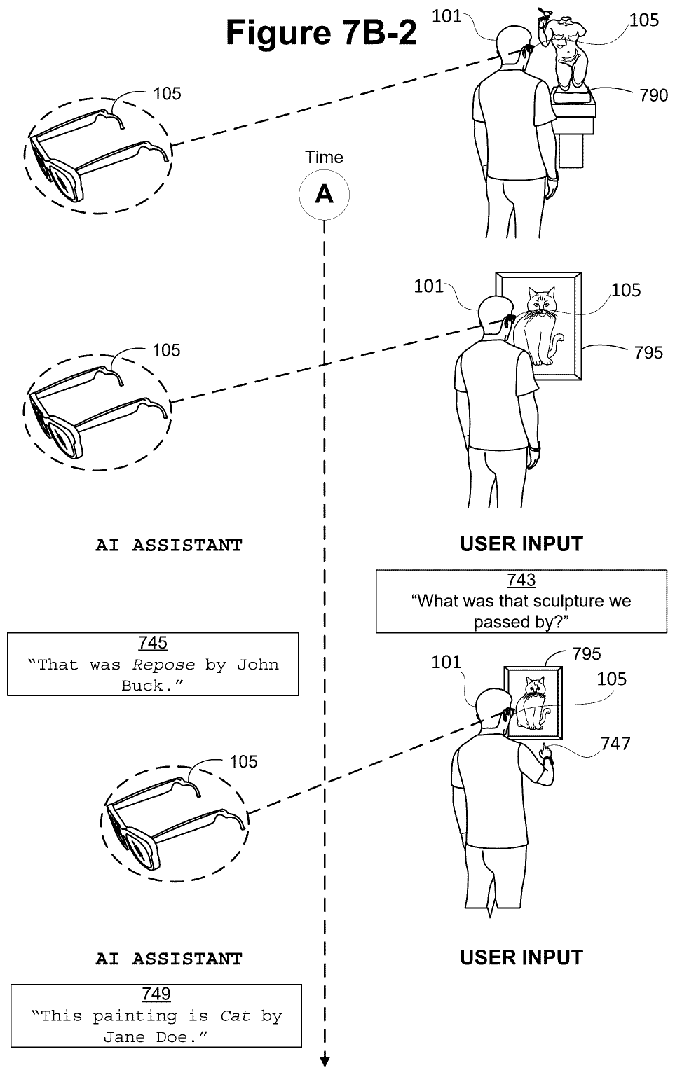

FIG. 7A illustrates the user 101 interacting with the AI assistant throughout an extended AI assistant session, in accordance with some embodiments. The user 101 performs an invocation command 701 (e.g., a voice command “Hey, I'm hungry for a snack.”) that is detected at the microphone of the head-wearable device 105. In response, the invocation command 701, the AI assistant is invoked at the head-wearable device 105, and the extended AI assistant session begins. In response to the invocation command 701, the AI assistant presents an invocation confirmation 703 (e.g., “What's in your kitchen? Maybe I can help.”) at the speaker of the head-wearable device 105. In some embodiments, the invocation confirmation 703 is based on the invocation command 701, as illustrated in FIG. 7. The user 101 performs a first query 705 (e.g., a voice command of “Can you help me pick one of these snacks?”), and, based on the first query 705, the AI assistant determines that it will be better able to answer the first query 705 if the AI assistant determines one or more objects in image data captured by the imaging device of the head-wearable device 105 (e.g., an image representing a field-of-view of the user 101). In response to the determination that the AI assistant will be better able to answer the first query 705 if the AI assistant determines one or more objects in the image data, the AI assistant presents a request 707 to activate the imaging device of the head-wearable device 105 (e.g., “Sure, turn on your camera so I can see what you have”). In response to the request 707, user 101 performs a camera activation command 709 (e.g., a voice command “Start looking.”). In response to the camera activation command 709, the AI assistant determines the one or more objects in the image data captured at the imaging device of the head-wearable device 105 and presents a camera confirmation 711 (e.g., “Started looking. ”) to the user 101. In response to the camera activation command 709, the AI assistant further prepares a comment on the image data 713 (e.g., “I see a few snack options, what are you in the mood for?”) and presents the comment on the image data 713 to the user 101. In some embodiments, the comment on the image data 713 is based on the previous command(s) made before the AI assistant determined the one or more objects in the image data, as illustrated in FIG. 7. The user 101 performs a second query 715 (e.g., a voice command “Can you tell me about this one?”). In response to the second query 715, the AI assistant prepares and presents a first response 717 (e.g., “These are potato chips, they are crunchy, lightly salted, and . . . ”) based on the second query 715, another previous query (e.g., the first query 705), the one or more objects in the image data, eye-tracking data (e.g., eye-tracking data indicates a particular object of the one or more objects in the image data that the user 101 is looking at when they perform the second query 715) received from an eye-tracking camera of the head-wearable device 105, a predicted intent of the user 101, additional sensor data, and/or other contextual factors. While the AI assistant is presenting the first response 717, the user 101 performs a user barge-in 719 (e.g., the user interrupts the AI assistant to say “Alright, can you tell me about this pizza?”). In some embodiments, the AI assistant ceases presenting the first response 717 when the user 101 starts performing the user barge-in 719 (e.g., the first response 717 gets cut off at “These are potato chips, they are crunchy . . . ” when the user 101 starts performing the user barge-in 719), as illustrated in FIG. 7. In some embodiments, the user barge-in 719 includes a third query (e.g., “ . . . can you tell me about this pizza?”). In response to the third query, the AI assistant presents an intermediary response 721 (e.g., “Pizza? Got it.”). In some embodiments, the intermediary response 721 is based on the third query, as illustrated in FIG. 7. After providing the intermediary response 721, the AI assistant provides a full response 723 (e.g., “It's a pepperoni pizza from a local pizzeria, it has a spicy sauce and . . . ”) based on the third query.

FIGS. 7B-1 and 7B-2 illustrate the user 101 interacting with the AI assistant throughout another extended AI assistant session, in accordance with some embodiments. The user 101 performs another invocation command 731 (e.g., a voice command “Start session.”) that is detected at the microphone of the head-wearable device 105. In response, the other invocation command 731, the AI assistant is invoked at the head-wearable device 105, and the other extended AI assistant session begins. In response to the other invocation command 731, the AI assistant presents another invocation confirmation 733 (e.g., “Session starting now.”) at the speaker of the head-wearable device 105. In some embodiments, the other invocation confirmation 733 is based on the other invocation command 731, as illustrated in FIG. 7B-1. In response to the other invocation command 731, the AI assistant further prepares another comment on the image data 735 (e.g., “Looks like we're at the city museum.”) and presents the other comment on the image data 735 to the user 101. In some embodiments, the comment on the image data 735 is based on the image data captured by the imaging device of the head-wearable device 105 and/or additional information (e.g., calendar information, location information, previous voice commands, etc.). The user 101 performs a fourth query 737 (e.g., a voice command “Yeah, what should we see first?”). In response to the fourth query 737, the AI assistant prepares and presents a third response 739 (e.g., “The City Museum has the largest collection of works by Jane Doe, let's check it out.”) based on the fourth query 737, an interaction between the AI assistant and the user 101 (e.g., the other comment on the image data 735), one or more other objects in the image data, a predicted intent of the user 101, additional sensor data, and/or other contextual factors. FIG. 7B-1 further illustrates the user 101 interacting another person (e.g., a ticket vendor) while the other extended AI session is ongoing, in accordance with some embodiments. In response to a determination that the user 101 is not directing their communication toward the AI assistant, the AI assistant ignores any comments 741 (e.g., “Hi, can I buy one ticket please?”) while the user 101 is not directing their communication toward the AI assistant. The AI assistant does not prepare any comments in response to the any comments 741 while the user 101 is not directing their communication toward the AI assistant.

FIG. 7B-2 illustrates the user 101 looking at an object 790 (e.g., an item, a person, a building, etc.) (e.g., a sculpture, as illustrated in FIG. 7B-2) at a first point in time while the other extended AI session is ongoing, in accordance with some embodiments. In some embodiments, the imaging device of the head-wearable device 105 captures image data including the object 790 at the first point in time. FIG. 7B-2 further illustrates the user 101 looking at another object 795 (e.g., a painting, as illustrated in FIG. 7B-2) at a second point in time, after the first point in time, while the other extended AI session is ongoing, in accordance with some embodiments. The user 101 performs a fifth query 743 (e.g., a voice command “What was that sculpture we passed by?”). In response to the fifth query 743, the AI assistant prepares and presents a fourth response 745 (e.g., “That was Repose by John Buck.”) based on the fifth query 743, the image data including the object 790 at the first point in time, one or more other objects in the image data, a predicted intent of the user 101, additional sensor data, and/or other contextual factors. FIG. 7B-2 further illustrates the user 101 performing a point hand gesture 747 (e.g., a finger point gesture) directed at the other object 795 while the other extended AI session is ongoing, in accordance with some embodiments. In response to the point hand gesture 747, the AI assistant prepares and presents a fifth response 749 (e.g., “This painting is Cat by Jane Doe.”) based on the point hand gesture 747, the image data including the other object 795, one or more other objects in the image data, a predicted intent of the user 101, additional sensor data, and/or other contextual factors. In some embodiments, the user 101 performs the point hand gesture 747 without performing any voice command, as illustrated in FIG. 7B-2. In some embodiments, the point hand gesture 747 is determined based on the image data captured by the imaging device of the head-wearable device 105 (e.g., the point hand gesture 747 is captured in the image data) and/or biopotential data from one or more biopotential sensors (e.g., an EMG sensor and/or an IMU sensor) communicatively coupled to the head-wearable device 105 (e.g., the one or more biopotential sensors at a smart watch, worn by the user 101 that is communicatively coupled to the head-wearable device 105).

In some embodiments, the user 101 terminates the other extended AI assistant session by performing a termination user input (e.g., a termination voice command, a termination hand gesture, tapping a portion of the head-wearable device 105). In some embodiments, the user 101 terminates the other extended AI assistant session in response to a determination that a maximum session time (e.g., forty-five minutes) has elapsed since the other extended AI assistant session began. In some embodiments, the user 101 terminates the other extended AI assistant session in response to a determination that a timeout session time (e.g., fifteen minutes) has elapsed since a most recent input of the one or more inputs has been performed by the user 101 (e.g., if the user 101 does not perform any inputs for the timeout session time, the other extended AI assistant session is terminated).

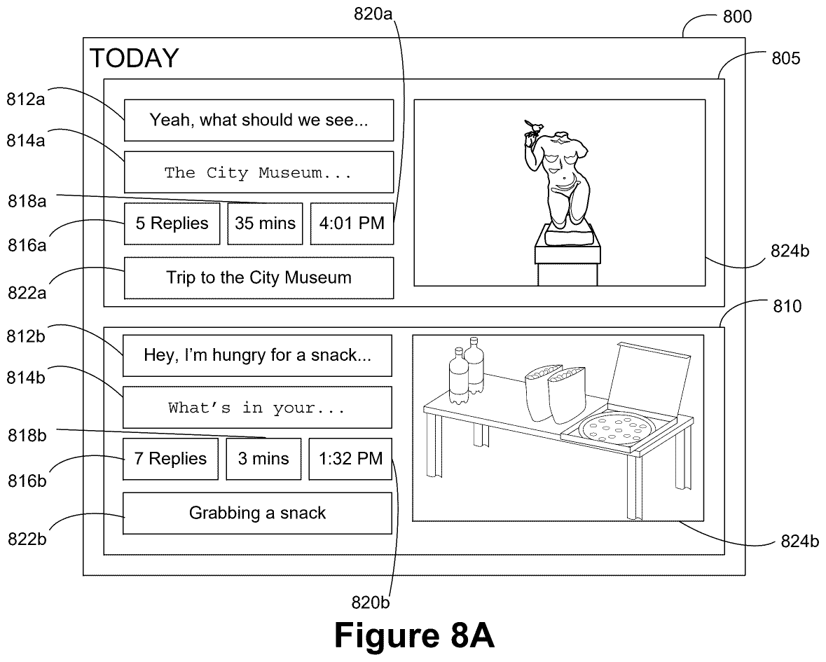

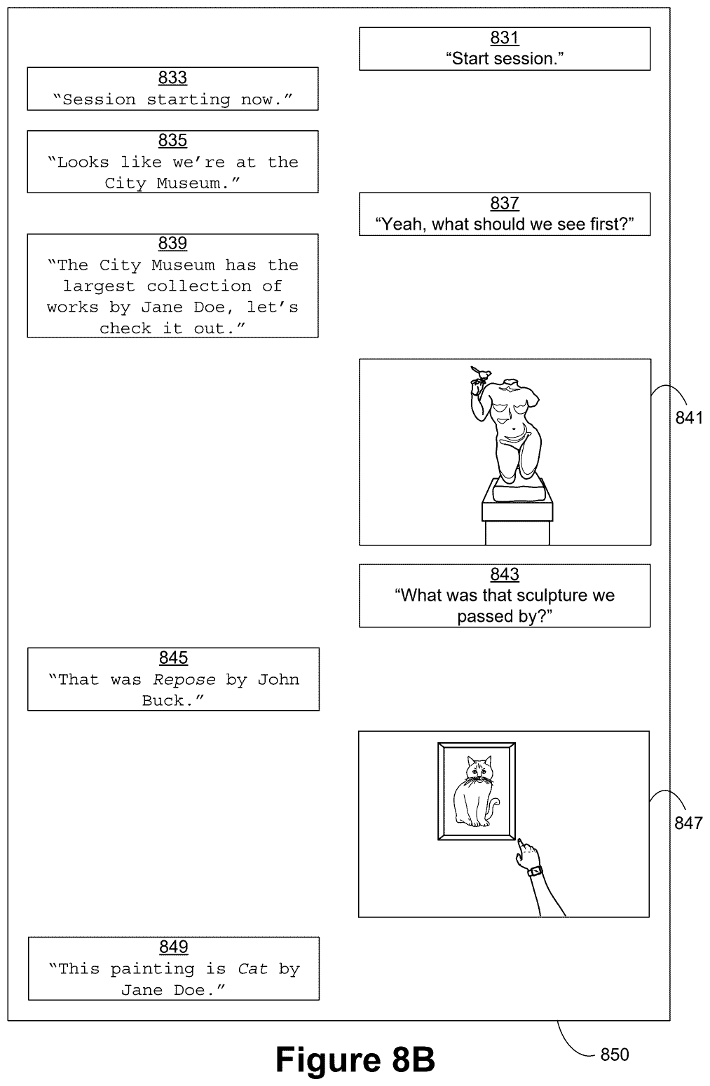

FIG. 8A illustrates a menu user interface (UI) 800 including one or more session information sets, in accordance with some embodiments. In some embodiments, the menu UI 800 is displayed at the head-wearable device 105 and/or another device (e.g., a smartphone, a handheld intermediary processing device, a personal computer, etc.) communicatively coupled to the head-wearable device 105. The menu UI 800 includes one or more session archive UI elements (e.g., a first session archive UI element 805 and a second session archive UI element 810). In some embodiments, the menu UI 800 presents the one or more session archive UI elements in a chronological order. Each respective session archive UI element of the one or more session archive UI elements is associated with one or more extended AI assistant sessions (e.g., the extended AI assistant session described in reference to FIG. 7A and/or the other extended AI assistant session described in reference to FIGS. 7B-1 and 7B-2). Each extended AI assistant session includes one or more inputs from the user 105 (e.g., the invocation command 701, the first query 705, the user barge-in 719, the fourth query 737, etc.), one or more responses to the user 105 (e.g., the invocation confirmation 703, the request 707, the other comment on the image data 735, the third response 739, etc.), and/or one or more images (e.g., the image data captured by the imaging device of the head-wearable device 105) from the respective extended AI assistant session. In some embodiments, the head-wearable device 105 transmits a respective information set (including the one or more inputs, the one or more responses, and/or the one or more images) to the other device, and the other device prepares the menu UI 800 and the one or more session archive UI elements to be presented to the user 101.

Each respective session archive UI element of the one or more session archive UI elements includes a respective input 812a-812b (e.g., “Yeah, what should we see . . . ” and/or “Hey, I'm hungry for a snack . . . ”) of the one or more inputs, a respective response 814a-814b (e.g., “The City Museum . . . ” and/or “What's in your . . . ”) of the one or more responses, a respective number of responses 816a-816b (e.g., “5 Replies” and/or “7 Replies”) in the respective extended AI assistant session, a respective length 818a-818b (e.g., “35 mins” and/or “3 mins”) of the respective extended AI assistant session, a respective timestamp 820a-820b (e.g., “4:01 PM” and/or “1:32 PM”) of the respective extended AI assistant session (e.g., a start time and/or an end time of the respective extended AI assistant session), a respective summary 822a-822b (e.g., “Trip to the City Museum” and/or “Grabbing a snack”) of the respective extended AI assistant session, and/or a respective image 824a-824b (e.g., a picture and/or a video from the image data captured during the respective extended AI assistant session) from the respective extended AI assistant session. In some embodiments, the respective input 812a-812b is an input that is a most representative input of the respective extended AI assistant session, as determined by the AI assistant, and/or is a first input of the respective extended AI assistant session. In some embodiments, the respective response 814a-814b is a response that is a most representative response of the respective extended AI assistant session, as determined by the AI assistant, and/or is a first response of the respective extended AI assistant session. In some embodiments, the respective summary 822a-822b is generated by the AI assistant based on the one or more inputs, the one or more responses, and/or the one or more images from the respective extended AI assistant session. In some embodiments, the respective image 824a-824b is an image and/or video that is a most representative image and/or video of the respective extended AI assistant session, as determined by the AI assistant. The user 101 can perform a select input to select a respective session archive UI element (e.g., a voice command “Show me my last session,” a touch input directed at the respective session, and/or a select hand gesture) of the one or more session archive UI elements to cause the head-wearable device 105 and/or the other device to present a session archive UI 850 associated with the respective extended AI assistant session.

FIG. 8B illustrates the session archive UI 850 associated with the other extended AI assistant session, described in reference to FIGS. 7B-1 and 7B-2 (e.g., in response to the user 101 selecting the first session archive UI element 805), in accordance with some embodiments. The session archive UI 850 includes a scrollable archive including the one or more inputs, the one or more responses, and/or the one or more images (e.g., pictures and/or videos) from the other extended AI assistant session. For example, the session archive UI 850 includes one or more textual representations of the one or more one or more inputs (e.g., a first textual representation 831 of the other invocation command 731, a fourth textual representation 837 of the fourth query 737, a sixth textual representation 843 of the fifth query 743, etc.), one or more textual representations of the one or more responses (e.g., a second textual representation 833 of the other invocation confirmation 733, a third textual representation 835 of the other comment on the image data 735, a fifth textual representation 839 of the third response 739, a seventh textual representation 845 of the fourth response 745, an eighth textual representation 849 of the fifth response 749, etc.), and/or one or more images from the respective extended AI assistant session (e.g., a first video clip 841, a second video clip 847, etc.), as determined by the AI assistant. In some embodiments, the one or more images includes one or more playable videos (e.g., including images and audio), and the user can perform a select input (e.g., a voice command “Show me that video,” a touch input, and/or a select hand gesture) to cause the one or more playable videos to play. In some embodiments, the one or more inputs, the one or more responses, and/or the one or more images are presented in the session archive 850 in chronological order, as illustrated in FIG. 8B. In some embodiments, the user 101 can perform a return input (e.g., a voice command “Go back to the menu,” a return touch input, and/or a return hand gesture) to cease displaying the session archive UI 850 and return to displaying the menu UI 800.

In some embodiments, the one or more textual representations of the one or more inputs are transcriptions of the one or more inputs, and/or the one or more textual representations of the one or more responses are transcriptions of the one or more responses. In some embodiments, in accordance with a determination that a respective image of the one or more images was used by the AI assistant to prepare a response, the respective image is included in the session archive UI 850. For example, in accordance with a determination that the first video clip 841 was used to prepare the fourth response 745, the AI assistant includes the first video clip 841 in the session archive UI 850. As another example, in accordance with a determination that the second video clip 847 was used to prepare the fifth response 749, the AI assistant includes the second video clip 847 in the session archive UI 850. In some embodiments, a remainder of the one or more images that are not associated with the one or more inputs from the user and/or the one or more responses are irrelevant images and are not included in the session archive UI 850. In some embodiments, in accordance with a determination that a respective input, performed by the user 101 during the respective extended AI assistant session, is an unintended input (e.g., the respective input was not directed at the AI assistant), the respective input is not included in the session archive UI 850. For example, the AI assistant determines that the comments 741 is an unintended input, and, thus, a textual representation of the comments 741 is not included in the session archive UI 850.

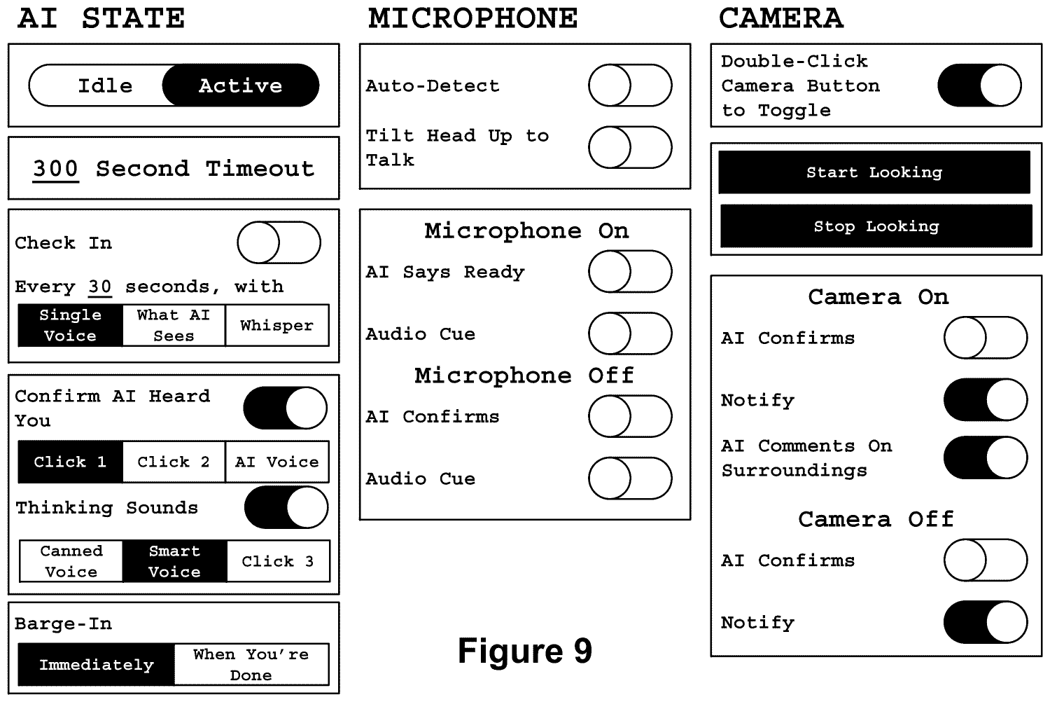

FIG. 9 illustrates an example of a user setting interface for assigning user settings that are applied to the AI assistant and AI assistant sessions, in accordance with some embodiments. The user setting interface indicates to the user 101 whether the AI assistant is in an active state or an idle state. The user setting interface indicates an AI assistant session timeout time (e.g., a period of time after which, if the user 101 has not interacted with the AI assistant, an active AI assistant session will end and the AI assistant will return to the idle state). In some embodiments, the user setting interface allows the user 101 to set the AI assistant session timeout time to a predetermined value (e.g., 300 seconds). The user setting interface indicates whether the AI assistant presents check-in phrases to the user 101 (e.g., as described in reference to FIG. 3), a check-in frequency (e.g., a period of time after which, if the user 101 has not interacted with the AI assistant, the AI assistant session will present the check-in phrase to the user 101), and a check-in phrase type (e.g., a single voice, such as “Need anything?” illustrated in FIG. 3, what the AI assistant sees, such as “I see a laptop and a monitor in front of you.” Illustrated in FIG. 3, and/or a whispered voice). In some embodiments, the user setting interface allows the user 101 to turn the check-in phrases on and off, set the check-in frequency to a predetermined value (e.g., 30 seconds), and/or select the check-in phrase type. The user setting interface indicates whether the AI assistant presents confirmation cues to the user 101 (e.g., as described in reference to FIGS. 5A-5B) and a confirmation cue type (e.g., an audio tone, a click sound, and/or a verbal audio cue, such as “Uh huh.”). In some embodiments, the user setting interface allows the user 101 to turn the confirmation cues on and off and/or select the confirmation cue type. The user setting interface indicates whether the AI assistant presents intermediary responses to the user 101 (e.g., as described in reference to FIGS. 4A-4B) and an intermediary response type (e.g., a canned voice, such as “One second.” illustrated in FIG. 4A, a smart voice, such as “Let's find the best route.” illustrated in FIG. 4B, and/or an audio cue). In some embodiments, the user setting interface allows the user 101 to turn the intermediary responses on and off and/or select the intermediary response type. The user setting interface indicates when the AI assistant stops a response to a user command in response to a user barge-in performed by the user 101 (e.g., as described in reference to FIGS. 2A-2D) (e.g., the AI assistant stops presenting the response to the user command only when the user 101 has finished performing the user barge-in, as illustrates in FIG. 2A, and/or the AI assistant stops presenting the response to the user command when the user 101 starts performing the user barge-in). In some embodiments, the user setting interface allows the user 101 to select when the AI assistant stops the response to the user command in response to the user barge-in performed by the user 101.

The user setting interface further allows the user 101 to toggle a plurality of microphone settings of the microphone of the head-wearable device 105. In some embodiments, the plurality of microphone settings includes (i) whether the AI assistant automatically detects (e.g., using a machine-learning algorithm) when the user 101 is requesting to talk with the AI assistant, (ii) whether the AI assistant detects that the user 101 is requesting to talk with the AI assistant when the user 101 tilts their head up, (iii) whether AI assistant presents a microphone activation vocal cue (e.g., “Microphone on.”) when the microphone is turned on, (iv) whether AI assistant presents a microphone activation audio cue (e.g., a first tone) when the microphone is turned on, (v) whether AI assistant presents a microphone deactivation vocal cue (e.g., “Microphone off.”) when the microphone is turned off, and/or (vi) whether AI assistant presents a microphone deactivation audio cue (e.g., a second tone) when the microphone is turned off.

The user setting interface further allows the user 101 to toggle a plurality of camera settings of the imaging device of the head-wearable device 105. In some embodiments, the plurality of microphone settings includes (i) whether the user can toggle the imaging device on and off by performing a double-click tap gesture at a camera button of the head-wearable device, (ii) whether the AI assistant must receive an explicit activation request (e.g., “Start looking.” as illustrated in FIG. 1A) from the user 101 to turn on the imaging device, (iii) whether the AI assistant must receive an explicit deactivation request (e.g., “Stop looking.” as illustrated in FIG. 1A) from the user 101 to turn off the imaging device, (iv) whether the AI assistant presents a camera activation vocal cue (e.g., “Camera on.”) when the imaging device is turned on, (v) whether the AI assistant presents a camera activation audio cue (e.g., a third tone) when the imaging device is turned on, (vi) whether the AI assistant presents a comment on the one or more objects in the image data (e.g., “Looks like you are in a workplace. Do you need any help?” as illustrated in FIG. 1B) when the imaging device is turned on, (vii) whether the AI assistant presents a camera deactivation vocal cue (e.g., “Camera off.”) when the imaging device is turned off, and/or (viii) whether the AI assistant presents a camera deactivation audio cue (e.g., a fourth tone) when the imaging device is turned off.

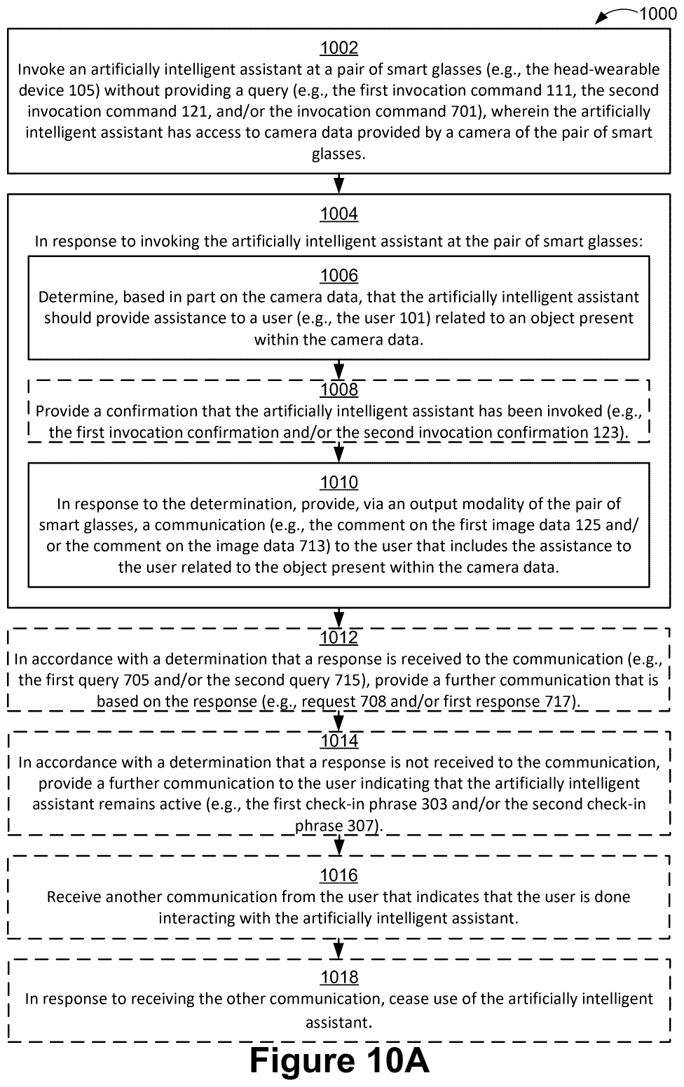

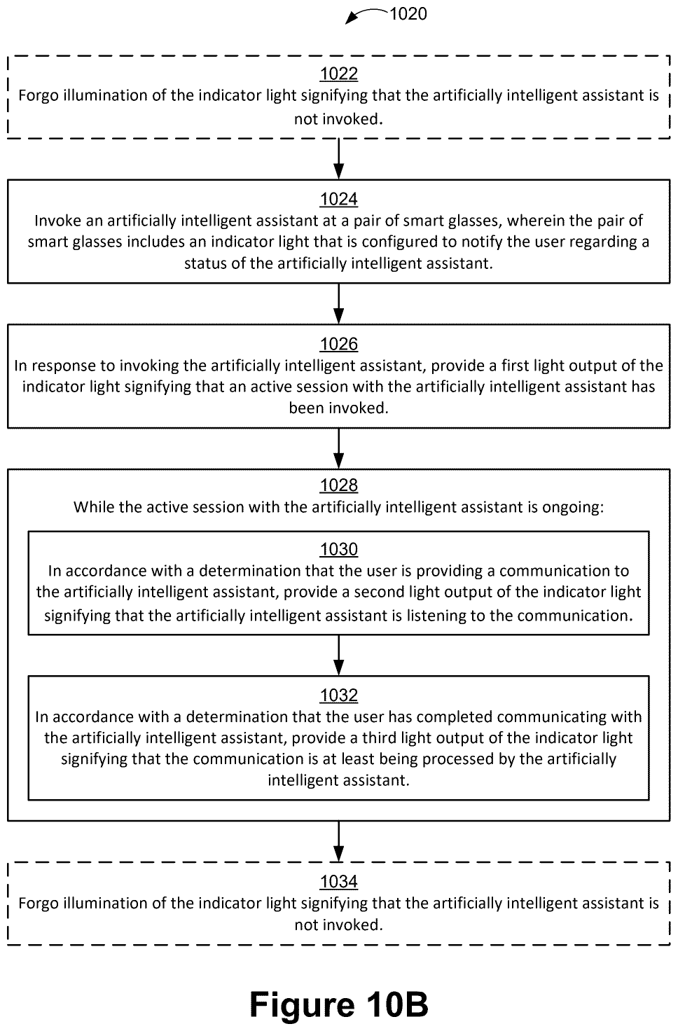

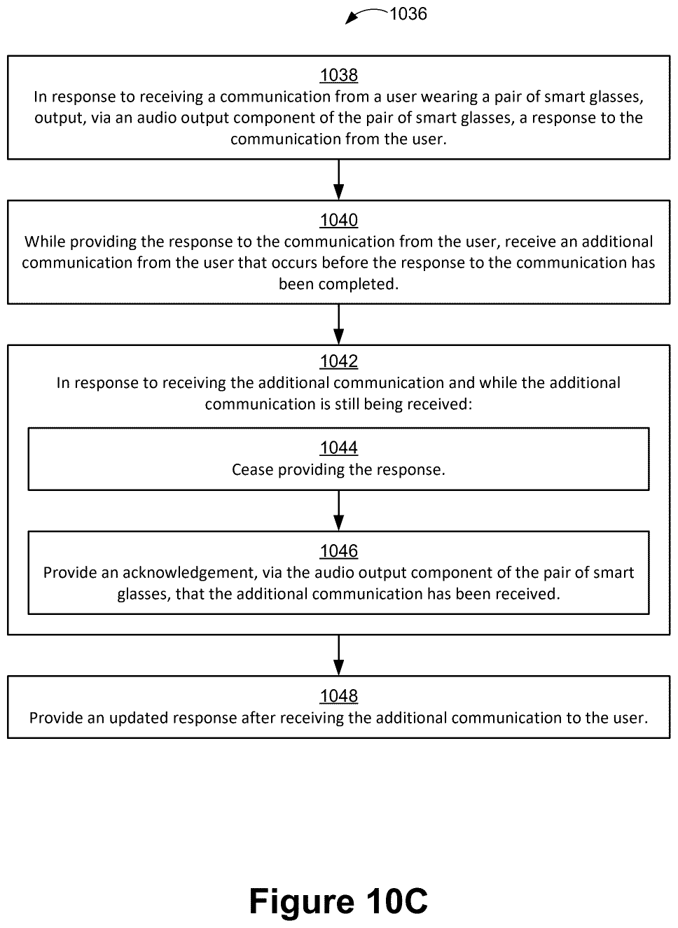

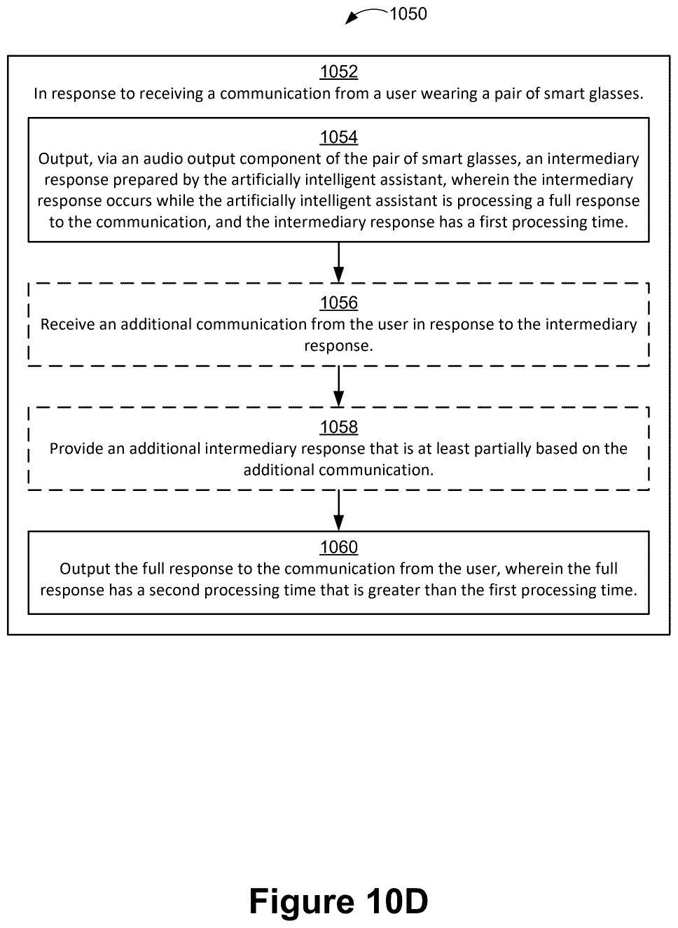

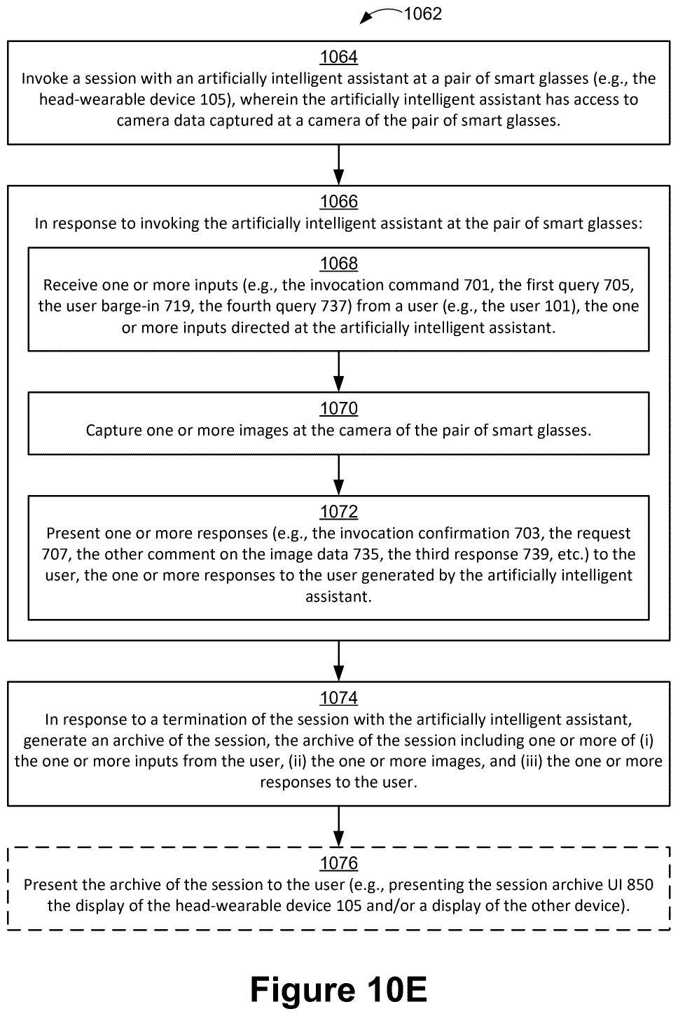

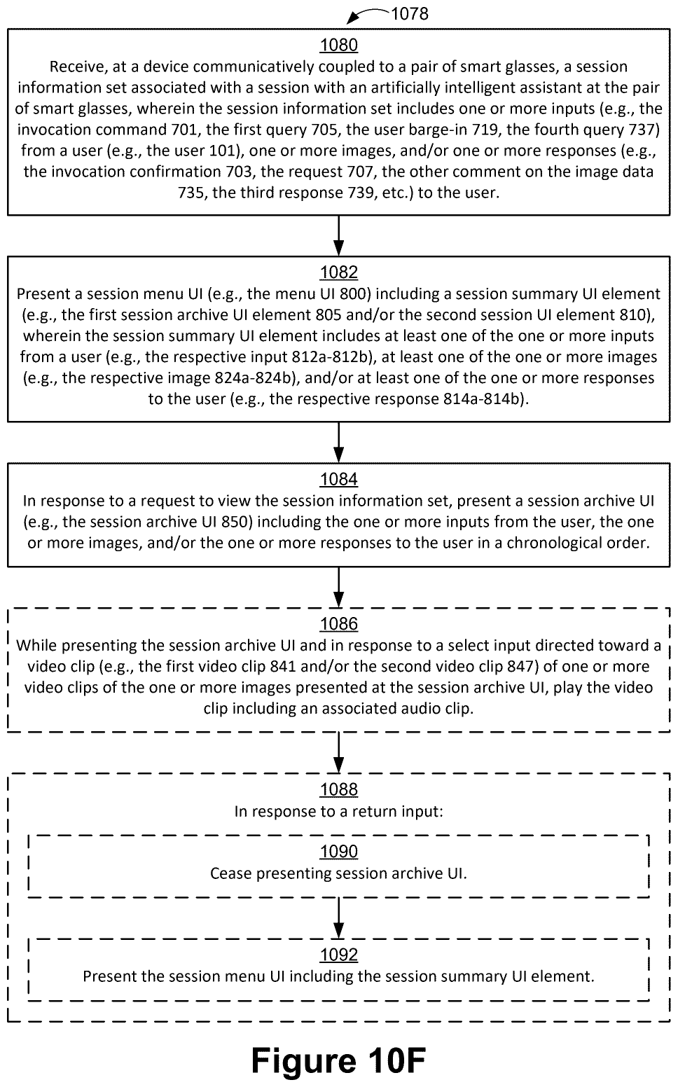

FIGS. 10A-10F illustrates flow diagrams of method for conversational interactions with an artificially intelligent assistant, in accordance with some embodiments. Operations (e.g., steps) of the method 1000, the method 1020, the method 1036, the method 1050, the method 1062, and/or the method 1078 can be performed by one or more processors (e.g., central processing unit and/or MCU) of a system including a head-wearable device. At least some of the operations shown in FIGS. 10A-10F correspond to instructions stored in a computer memory or computer-readable storage medium (e.g., storage, RAM, and/or memory). Operations of the method 1000, the method 1020, the method 1036, the method 1050, the method 1062, and/or the method 1078 can be performed by a single device alone or in conjunction with one or more processors and/or hardware components of another communicatively coupled device (e.g., a handheld intermediary processing device) and/or instructions stored in memory or computer-readable medium of the other device communicatively coupled to the head-wearable device. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.

(A1) FIG. 10A shows a flow chart of a method 1000 of providing, from an artificially intelligent (AI) assistant, a comment on the surroundings of a user upon invocation of the AI assistant, in accordance with some embodiments.

The method 1000 occurs at a pair of smart glasses (e.g., the head-wearable device 105) with a camera. In some embodiments, the method 1000 includes, invoking an AI assistant at the pair of smart glasses without providing a query (e.g., the first invocation command 111, the second invocation command 121, and/or the invocation command 701), wherein the artificially intelligent assistant has access to camera data provided by a camera of the pair of smart glasses (1002). The method 1000 further includes, in response to invoking the artificially intelligent assistant at the pair of smart glasses (1004), (i) determining, based in part on the camera data, that the AI assistant should provide assistance to a user (e.g., the user 101) related to an object present within the camera data (1006), and (ii) in response to the determining, providing, via an output modality of the pair of smart glasses, a communication (e.g., the comment on the first image data 125 and/or the comment on the image data 713) to the user that includes the assistance to the user related to the object present within the camera data (1010).

(A2) In some embodiments of A1, the method 1000 further includes, in accordance with a determination that a response is received to the communication (e.g., the first query 705 and/or the second query 715), providing a further communication that is based on the response (e.g., request 707 and/or first response 717) (1012) and in accordance with a determination that a response is not received to the communication, providing a further communication to the user indicating that the AI assistant remains active (e.g., the first check-in phrase 303 and/or the second check-in phrase 307) (1014).

(A3) In some embodiments of any of A1-A2, the communication is based on a predicted intent of the user.

(A4) In some embodiments of any of A1-A3, invoking the AI assistant includes performing a gesture (e.g., tapping the temple arm of the head-wearable device 105) at the pair of smart glasses.

(A5) In some embodiments of any of A1-A4, invoking the AI assistant occurs in response to the pair of smart glasses detecting a wake word (e.g., a wake word and/or a wake phrase such as “Hey Assistant,” and/or “Start looking” detected as a microphone of the head-wearable device 105) for invoking the artificially intelligent assistant.

(A6) In some embodiments of any of A1-A5, invoking the AI assistant includes providing an open-ended query (e.g., “What's the weather today?” and/or “Tell me my shopping list”).

(A7) In some embodiments of any of A1-A6, the method 1000 further includes, in response to invoking the AI assistant and before providing the communication to the user, providing a confirmation that the AI assistant has been invoked (e.g., the first invocation confirmation 113 and/or the second invocation confirmation 123) (1008).

(A8) In some embodiments of any of A1-A7, the method 1000 further includes, (i) after providing the communication to the user, receiving another communication from the user that indicates that the user is done interacting with the AI assistant (1016) (e.g., the first termination command 115) and, (ii) in response to receiving the other communication, ceasing use of the AI assistant (1018).

(A9) In some embodiments of any of A1-A8, the method 1000 further includes, in response to ceasing use of the AI assistant, providing a confirmation that the AI assistant is no longer in use (e.g., first termination confirmation 117).

(A10) In some embodiments of any of A1-A9, the communication to the user is generated based in part on providing information about the object present within the camera data to a large language model (e.g., a large language model (LLM) and/or a multimodal model).

(A11) In some embodiments of any of A1-A10, the communication to the user is further based on additional sensor data from sensors different from the camera (e.g., other sensors of the head-wearable device 105, such as an eye-tracking camera).

(A12) In some embodiments of any of A1-A11, the method 1000 further includes, further in response to invoking the artificially intelligent assistant at the pair of smart glasses: (i) determining, based in part on the camera data, that the AI assistant should provide assistance to the user related to an additional object, distinct form the object, present within the camera data, and (ii) in response to the determining, providing, via the output modality of the pair of smart glasses, an additional communication to the user that includes the assistance to the user related to the additional object present within the camera data.

(A13) In some embodiments of any of A1-A12, the communication to the user also includes an extended-reality (XR) augment presented at a display of the smart glasses.

(B1) In accordance with some embodiments, a non-transitory, computer-readable storage medium includes executable instructions that, when executed by one or more processors, cause the one or more processors to perform or cause performance of the methods of any one of A1-A13.

(C1) In accordance with some embodiments, means for performing or causing performance of the methods of any one of A1-A13.

(D1) In accordance with some embodiments, a pair of smart glasses (e.g., extended reality glasses, display-less smart glasses, mixed-reality headset, etc.) is configured to perform or cause performance of the methods of any one of A1-A13.

(E1) In accordance with some embodiments, an intermediary processing device (e.g., configured to offload processing operations for a head-worn device such as Augmented Reality glasses) is configured to perform or cause performance of the methods of any one of A1-A13.

(F1) FIG. 10B shows a flow chart of a method 1020 of providing different indicator light states based on a current state on an AI assistant, in accordance with some embodiments.

The method 1020 occurs at a pair of smart glasses (e.g., the head-wearable device 105) with at least one indicator light. In some embodiments, the method 1020 includes, invoking an AI assistant at the pair of smart glasses, the pair of smart glasses including an indicator light that is configured to notify a user (e.g., the user 101) regarding a status of the AI assistant (1024). The method 1020 further includes, in response to invoking the AI assistant, providing a first light output (e.g., the second light output 652) of the indicator light signifying that an active session with the AI assistant has been invoked (1026). The method 1020 further includes, while the active session with the AI assistant is ongoing (1028): (i) in accordance with a determination that the user is providing a communication to the AI assistant (e.g., the sixth user command 611), providing a second light output (e.g., the third light output 654) of the indicator light signifying that the AI assistant is listening to the communication (1030) and, (ii) in accordance with a determination that the user has completed communicating with the AI assistant, providing a third light output (e.g., the fourth light output 656) of the indicator light signifying that the communication is at least being processed by the AI assistant (1032).

(F2) In some embodiments of F1, the third light also signifies that the AI assistant is providing a response to the communication (e.g., as illustrated in FIG. 6B).

(F3) In some embodiments of any of F1-F2, the first light output of the indicator light that signifies that an active session with the AI assistant has been invoked is solid light.

(F4) In some embodiments of any of F1-F3, the second light output of the indicator light that signifies that the AI assistant is listening to the communication is a pulsating light with a first luminosity.

(F5) In some embodiments of any of F1-F4, the third light output of the indicator light that signifies that the communication is at least being processed by the AI assistant is a pulsating light with a second luminosity that is different than the first luminosity.

(F6) In some embodiments of any of F1-F5, the indicator light is located on the frame of the smart glasses, such that the user can see the indicator light in their periphery view.

(F7) In some embodiments of any of F1-F6, the method 1020 further includes, before invoking an AI assistant at a pair of smart glasses, forgoing illumination of the indicator light signifying that the artificially intelligent assistant is not invoked (1022).

(F8) In some embodiments of any of F1-F7, the method 1020 further includes, after providing the third light output of the indicator light signifying that the communication is at least being processed by the artificially intelligent assistant, forgoing illumination of the indicator light signifying that the artificially intelligent assistant is not invoked (1034).

(F9) In some embodiments of any of F1-F8, the first light output of the indicator light that signifies that an active session with the artificially intelligent assistant has been invoked is first color.

(F10) In some embodiments of any of F1-F9, the second light output of the indicator light that signifies that the artificially intelligent assistant is listening to the communication is a second color that is different from the first color.

(F11) In some embodiments of any of F1-F10, the third light output of the indicator light that signifies that the communication is at least being processed by the artificially intelligent assistant is a third color that is different than the first color and second color.

(F12) In some embodiments of any of F1-F11, an XR augment displayed at the pair of smart glasses is configured to further provide a status of the artificially intelligent assistant.

(F13) In some embodiments of any of F1-F12, the indicator light is configured to provide additional notifications to the user other than a status of the artificially intelligent assistant.

(F14) In some embodiments of any of F1-F13, the indicator light is placed on an interior surface of the pair of smart glasses, such that it is visible to the user while donned.

(G1) In accordance with some embodiments, a non-transitory, computer-readable storage medium includes executable instructions that, when executed by one or more processors, cause the one or more processors to perform or cause performance of the methods of any one of F1-F14.

(H1) In accordance with some embodiments, means for performing or causing performance of the methods of any one of F1-F14.

(I1) In accordance with some embodiments, a pair of smart glasses (e.g., extended reality glasses, display-less smart glasses, mixed-reality headset, etc.) is configured to perform or cause performance of the methods of any one of F1-F14.

(J1) In accordance with some embodiments, an intermediary processing device (e.g., configured to offload processing operations for a head-worn device such as Augmented Reality glasses) is configured to perform or cause performance of the methods of any one of F1-F14.

(K1) FIG. 10C shows a flow chart of a method 1036 of providing, from an AI assistant, an acknowledgement of a barge-in communication from a user performed while the AI assistant is outputting a response, in accordance with some embodiments.

The method 1036 occurs at a pair of smart glasses (e.g., the head-wearable device 105) with a speaker. In some embodiments, the method 1036 includes, in response to receiving a communication (e.g., the third initial command 221) from a user (e.g., the user 101) wearing the pair of smart glasses, outputting, via an audio output component of the pair of smart glasses, a response (e.g., the third response 223) to the communication from the user (1038). The method 1036 further includes, while providing the response to the communication from the user, receiving an additional communication (e.g., the third user barge-in 225) from the user that occurs before the response to the communication has been completed (1040). The method 1036 further includes, in response to receiving the additional communication and while the additional communication is still being received (1042): (i) ceasing providing the response (1044) and providing an acknowledgement (e.g., the acknowledgement sound 227 and/or the acknowledgement phrase 237), via the audio output component of the pair of smart glasses, that the additional communication has been received (1046). The method 1036 further includes, providing an updated response after receiving the additional communication to the user (1048).

(K2) In some embodiments of K1, the updated response is based on at least the first communication and the additional communication.

(K3) In some embodiments of any of K1-K2, the additional communication is at least partially based on the communication.

(K4) In some embodiments of any of K1-K3, the updated response to the user also includes an XR augment presented at a display of the smart glasses.

(K5) In some embodiments of any of K1-K4, the updated response is distinct from a remainder of the response that was not provided to the user.

(K6) In some embodiments of any of K1-K5, the response and the updated response provided to the user can also include an extended-reality augment presented at a display of the smart glasses.

(K7) In some embodiments of any of K1-K6, the acknowledgement is an audible natural language response (e.g., the acknowledgement phrase 237).

(K8) In some embodiments of any of K1-K7, the communication and the additional communication are audible natural language responses.

(K9) In some embodiments of any of K1-K8, the additional communication includes a correction to a misinterpretation provided in the response to the communication from the user, and the updated response takes into account the correction to the misinterpretation.

(K10) In some embodiments of any of K1-K9, at least two of the response, the acknowledgement, and the updated response are produced by an artificially intelligent assistant.

(L1) In accordance with some embodiments, a non-transitory, computer-readable storage medium includes executable instructions that, when executed by one or more processors, cause the one or more processors to perform or cause performance of the methods of any one of K1-K10.

(M1) In accordance with some embodiments, means for performing or causing performance of the methods of any one of K1-K10.

(N1) In accordance with some embodiments, a pair of smart glasses (e.g., extended reality glasses, display-less smart glasses, mixed-reality headset, etc.) is configured to perform or cause performance of the methods of any one of K1-K10.

(O1) In accordance with some embodiments, an intermediary processing device (e.g., configured to offload processing operations for a head-worn device such as Augmented Reality glasses) is configured to perform or cause performance of the methods of any one of K1-K10.

(P1) FIG. 10D shows a flow chart of a method 1050 of providing, from an AI assistant, filler response while the AI assistant is processing a full response to a communication from a user, in accordance with some embodiments.

The method 1050 occurs at a pair of smart glasses (e.g., the head-wearable device 105) with a speaker. In some embodiments, the method 1050 includes, in response to receiving a communication (e.g., the first user command 401 and/or the second user command 411) from a user (e.g., the user 101) wearing a pair of smart glasses (1052): (i) outputting, via an audio output component of the pair of smart glasses, an intermediary response (e.g., the first intermediary response 403 and/or the second intermediary response 413) prepared by the AI assistant, wherein the intermediary response occurs while the AI assistant is processing a full response (e.g., the first full response 405 and/or the second full response 415) to the communication and the intermediary response has a first processing time (1054), and, (ii) after outputting the intermediary response, outputting the full response to the communication from the user, wherein the full response has a second processing time that is greater than the first processing time (1060).

(P2) In some embodiments of P1, the intermediary response is prepared by a first LLM and the full response is a prepared by a second LLM that is different than the first LLM.

(P3) In some embodiments of any of P1-P2, the intermediary response is at least partially based on the communication from the user.

(P4) In some embodiments of any of P1-P3, the full response is at least partially based on the communication from the user.

(P5) In some embodiments of any of P1-P4, the intermediary response is audible tone that signifies receipt of the communication.

(P6) In some embodiments of any of P1-P5, the intermediary response confirms receipt of the communication.

(P7) In some embodiments of any of P1-P6, confirmation of receipt of the communication occurs using a natural language response.

(P8) In some embodiments of any of P1-P7, the method 1050 further includes before outputting the full response: (i) receiving an additional communication from the user in response to the intermediary response (1056) and (ii) providing an additional intermediary response that is at least partially based on the additional communication (1058). The full response is further based on the additional communication.

(Q1) In accordance with some embodiments, a non-transitory, computer-readable storage medium includes executable instructions that, when executed by one or more processors, cause the one or more processors to perform or cause performance of the methods of any one of P1-P8.

(R1) In accordance with some embodiments, means for performing or causing performance of the methods of any one of P1-P8.

(S1) In accordance with some embodiments, a pair of smart glasses (e.g., extended reality glasses, display-less smart glasses, mixed-reality headset, etc.) is configured to perform or cause performance of the methods of any one of P1-P8.

(T1) In accordance with some embodiments, an intermediary processing device (e.g., configured to offload processing operations for a head-worn device such as Augmented Reality glasses) is configured to perform or cause performance of the methods of any one of P1-P8.

(U1) In FIG. 10E shows a flow chart of a method 1062 for generating an archive of a session with an artificially intelligent assistant at a pair of smart glasses, in accordance with some embodiments.

The method 1062 occurs at a pair of smart glasses (e.g., the head-wearable device 105) with a one or more cameras, one or more microphones, and/or one or more speakers. In some embodiments, the method 1062 includes, invoking a session with an artificially intelligent assistant (e.g., the extended AI assistant session, described in reference to FIG. 7A, and/or the other extended AI assistant session, described in reference to FIGS. 7B-1-7B-2) at the pair of smart glasses, wherein the artificially intelligent assistant has access to camera data captured at a camera of the pair of smart glasses (1064). The method 1062 further includes in response to invoking the artificially intelligent assistant at the pair of smart glasses (e.g., in response to the invocation command 701 and/or the other invocation command 731) (1066): (i) receiving one or more inputs (e.g., the invocation command 701, the first query 705, the camera activation command 709, the second query 715, the user barge-in 719, the other invocation command 731, the fourth query 737, the fifth query 743, and/or the point hand gesture 747) from a user (e.g., the user 101), the one or more inputs directed at the artificially intelligent assistant (1068), (ii) capturing one or more images (e.g., image data and/or video data (further including audio data) captured while the camera (and the microphone) of the pair of smart glasses is activated during the session with the artificially intelligent assistant) at the camera of the pair of smart glasses (1070), and (iii) presenting (e.g., at the speaker of the head-wearable device and/or at the display of the head-wearable device) one or more responses (e.g., the invocation confirmation 703, the response to the request 707, the camera confirmation 711, the comment on the image data 713, the first response 717, the intermediary response 721, the full response 723, the other invocation confirmation 733, the other comment on the image data 735, the third response 739, the fourth response 745, and/or the fifth response 749) to the user, the one or more responses to the user generated by the artificially intelligent assistant (1072). The method 1062 further includes, in response to a termination of the session with the artificially intelligent assistant, generating an archive of the session, the archive of the session including one or more of: (i) the one or more inputs from the user (e.g., a first textual representation 831 of the other invocation command 731, a fourth textual representation 837 of the fourth query 737, and/or a sixth textual representation 843 of the fifth query 743), (ii) the one or more images (e.g., a first video clip 841 and/or the second video clip 847), and (iii) the one or more responses to the user (e.g., a second textual representation 833 of the other invocation confirmation 733, a third textual representation 835 of the other comment on the image data 735, a fifth textual representation 839 of the third response 739, a seventh textual representation 845 of the fourth response 745, and/or an eighth textual representation 849 of the fifth response 749) (1074).

(U2) In some embodiments of U1, the archive of the session is generated by the artificially intelligent assistant.

(U3) In some embodiments of any of U1-U2, the archive of the session does not include one or more unintended inputs (e.g., the comments 741) of the one or more inputs from the user, and the one or more unintended inputs is a subset of the one or more inputs from the user that are not directed toward the artificially intelligent assistant.

(U4) In some embodiments of any of U1-U3, the archive of the session does not include one or more irrelevant images of the one or more images, and the one or more irrelevant images is a subset of the one or more images that are not associated with the one or more inputs from the user and/or the one or more responses.

(U5) In some embodiments of any of U1-U4, the method 1062 further includes presenting the archive of the session to the user (e.g., presenting the session archive UI 850 the display of the head-wearable device 105 and/or a display of the other device) (1076).

(U6) In some embodiments of any of U1-U5, presenting the archive of the session to the user includes presenting a respective textual representation of each of the one or more inputs from the user, the one or more images, and/or a respective textual representation of each of the one or more response to the user.

(U7) In some embodiments of any of U1-U6, the method 1062 further includes generating a summary of the archive of the session (e.g., the first session UI element 805 and/or the second session archive UI element 810) and presenting the summary of the archive of the session to the user.

(U8) In some embodiments of any of U1-U7, the summary of the archive of the session includes one or more of: (i) a textual summary of the session (e.g., the respective summary 822a-822b), generated by the artificially intelligent assistant, (ii) a timestamps (e.g., the respective timestamp 820a-820b), indicating a time that the session began and/or a time that the session ended, (iii) a time duration (e.g., the respective length 818a-818b), indicating a length of the session, (iv) a number of responses presented to the user during session (e.g., the respective number of responses 816a-816b), (v) at least one of the one or more images (e.g., the respective image 824a-824b).

(U9) In some embodiments of any of U1-U8, the method 1062 further includes invoking another session with the artificially intelligent assistant at the pair of smart glasses. The method 1062 further includes, in response to invoking the artificially intelligent assistant at the pair of smart glasses (e.g., in response to the invocation command 701 and/or the other invocation command 731): (i) receiving one or more other inputs (e.g., the invocation command 701, the first query 705, the camera activation command 709, the second query 715, the user barge-in 719, the other invocation command 731, the fourth query 737, the fifth query 743, and/or the point hand gesture 747) from the user, the one or more other inputs directed at the artificially intelligent assistant, (ii) capturing one or more other images (e.g., image data and/or video data (further including audio data) captured while the camera (and the microphone) of the pair of smart glasses is activated during the session with the artificially intelligent assistant) at the camera of the pair of smart glasses, and (iii) presenting one or more other responses (e.g., the invocation confirmation 703, the response to the request 707, the camera confirmation 711, the comment on the image data 713, the first response 717, the intermediary response 721, the full response 723, the other invocation confirmation 733, the other comment on the image data 735, the third response 739, the fourth response 745, and/or the fifth response 749) to the user, the one or more other responses to the user generated by the artificially intelligent assistant. The method 1062 further includes, in response to a termination of the other session with the artificially intelligent assistant, generating another archive of the other session, the other archive of the other session including one or more of: (i) the one or more other inputs from the user (e.g., a first textual representation 831 of the other invocation command 731, a fourth textual representation 837 of the fourth query 737, and/or a sixth textual representation 843 of the fifth query 743), (ii) the one or more other images (e.g., a first video clip 841 and/or the second video clip 847), and/or (iii) the one or more other responses to the user (e.g., a second textual representation 833 of the other invocation confirmation 733, a third textual representation 835 of the other comment on the image data 735, a fifth textual representation 839 of the third response 739, a seventh textual representation 845 of the fourth response 745, and/or an eighth textual representation 849 of the fifth response 749).

(U10) In some embodiments of any of U1-U9, the method 1062 further includes presenting the archive of the session and the other archive of the other session to the user (e.g., presenting the session archive UI 850 the display of the head-wearable device 105 and/or a display of the other device).

(U11) In some embodiments of any of U1-U10, the one or more inputs from the user includes one or more point gestures (e.g., the point hand gesture 747) directed at one or more objects (e.g., the other object 795) in the one or more images, and generating the one or more responses to the user (e.g., the fifth response 749) is based on the one or more objects.

(U12) In some embodiments of any of U1-U11, (i) the one or more inputs from the user includes one or more voice commands (e.g., the second query 715, the user barge-in 719, and/or the fifth query 743) directed at one or more objects (e.g., the object 790) in the one or more images, (ii) generating the one or more responses (e.g., the first response 717, the intermediary response 721, the full response 723, and/or the fourth response 745) to the user is based on the one or more objects, (iii) the one or more images are captured at a first point in time, and (iv) the one or more voice commands are captured at a second point in time after the first point in time and while the user is not looking at the one or more objects (e.g., as described in reference to FIG. 7B-2).

(U13) In some embodiments of any of U1-U12, the termination of the session with the AI assistant is in response to a termination user input performed by the user.

(U14) In some embodiments of any of U1-U13, the termination of the session with the AI assistant is in response to a determination that a termination period of time has elapsed since the session with the AI assistant was invoked.

(U15) In some embodiments of any of U1-U14, the termination of the session with the AI assistant is in response to a determination that a timeout period of time has elapsed since a most recent input of the one or more inputs from the user.

(V1) In accordance with some embodiments, a non-transitory, computer-readable storage medium includes executable instructions that, when executed by one or more processors, cause the one or more processors to perform or cause performance of the methods of any one of U1-U15.

(W1) In accordance with some embodiments, means for performing or causing performance of the methods of any one of U1-U15.

(X1) In accordance with some embodiments, a pair of smart glasses (e.g., extended reality glasses, display-less smart glasses, mixed-reality headset, etc.) is configured to perform or cause performance of the methods of any one of U1-U15.

(Y1) In accordance with some embodiments, an intermediary processing device (e.g., configured to offload processing operations for a head-worn device such as Augmented Reality glasses) is configured to perform or cause performance of the methods of any one of U1-U15.

(Z1) In FIG. 10F shows a flow chart of a method 1078 for presenting an archive of a session with an artificially intelligent assistant at a pair of smart glasses, in accordance with some embodiments.

The method 1078 occurs at a pair of smart glasses (e.g., the head-wearable device 105) and/or a device communicatively coupled to the pair of smart glasses (e.g., the other device). In some embodiments, the method 1078 includes, receiving, at the device communicatively coupled to the pair of smart glasses, a session information set associated with a session with an artificially intelligent assistant at the pair of smart glasses (e.g., the extended AI assistant session, described in reference to FIG. 7A, and/or the other extended AI assistant session, described in reference to FIGS. 7B-1-7B-2), wherein the session information set includes one or more inputs (e.g., the invocation command 701, the first query 705, the camera activation command 709, the second query 715, the user barge-in 719, the other invocation command 731, the fourth query 737, the fifth query 743, and/or the point hand gesture 747) from a user (e.g., the user 101), one or more images (e.g., image data and/or video data (further including audio data) captured while the camera (and the microphone) of the pair of smart glasses is activated during the session with the artificially intelligent assistant), and/or one or more responses (e.g., the invocation confirmation 703, the response to the request 707, the camera confirmation 711, the comment on the image data 713, the first response 717, the intermediary response 721, the full response 723, the other invocation confirmation 733, the other comment on the image data 735, the third response 739, the fourth response 745, and/or the fifth response 749) to the user (1080). The method 1078 further includes presenting a session menu UI (e.g., the menu UI 800) including a session summary UI element (e.g., the first session archive UI element 805 and/or the second session UI element 810), wherein the session summary UI element includes at least one of the one or more inputs from the user (e.g., the respective input 812a-812b), at least one of the one or more images (e.g., the respective image 824a-824b), and/or at least one of the one or more responses to the user (e.g., the respective response 814a-814b) (1082). The method 1078 further includes, in response to a request to view the session information set (e.g., the select input, described in reference to FIG. 8A), presenting a session archive UI (e.g., the session archive UI 850) including the one or more inputs from the user, the one or more images, and/or the one or more responses to the user in a chronological order.

(Z2) In some embodiments of Z1, the summary of the session information set is generated by the artificially intelligent assistant.

(Z3) In some embodiments of any of Z1-Z2, the session information set does not include one or more unintended inputs of the one or more inputs (e.g., the comments 741) from the user, and the one or more unintended inputs is a subset of the one or more inputs from the user that are not directed toward the artificially intelligent assistant.

(Z4) In some embodiments of any of Z1-Z3, the session information set does not include one or more irrelevant images of the one or more images, and the one or more irrelevant images is a subset of the one or more images that are not associated with the one or more inputs from the user and/or the one or more responses.

(Z5) In some embodiments of any of Z1-Z4, presenting the session archive UI includes a respective textual representation of each of the one or more inputs from the user (e.g., a first textual representation 831 of the other invocation command 731, a fourth textual representation 837 of the fourth query 737, and/or a sixth textual representation 843 of the fifth query 743), the one or more images (e.g., a first video clip 841 and/or the second video clip 847), and/or a respective textual representation of each of the one or more response to the user (e.g., a second textual representation 833 of the other invocation confirmation 733, a third textual representation 835 of the other comment on the image data 735, a fifth textual representation 839 of the third response 739, a seventh textual representation 845 of the fourth response 745, and/or an eighth textual representation 849 of the fifth response 749) in a chronological order.

(Z6) In some embodiments of any of Z1-Z5, the summary of the archive of the session includes one or more of: (i) a textual summary of the session (e.g., the respective summary 822a-822b), generated by the artificially intelligent assistant, (ii) a timestamps (e.g., the respective timestamp 820a-820b), indicating a time that the session began and/or a time that the session ended, (iii) a time duration (e.g., the respective length 818a-818b), indicating a length of the session, (iv) a number of responses presented to the user during session (e.g., the respective number of responses 816a-816b), (v) at least one of the one or more images (e.g., the respective image 824a-824b).

(Z7) In some embodiments of any of Z1-Z6, the method 1078 further includes receiving, at the device communicatively coupled to the smart glasses, another session information set associated with another session with the artificially intelligent assistant at the pair of smart glasses (e.g., the extended AI assistant session, described in reference to FIG. 7A, and/or the other extended AI assistant session, described in reference to FIGS. 7B-1-7B-2), wherein the other session information set includes one or more other inputs from the user (e.g., the invocation command 701, the first query 705, the camera activation command 709, the second query 715, the user barge-in 719, the other invocation command 731, the fourth query 737, the fifth query 743, and/or the point hand gesture 747), one or more other images (e.g., image data and/or video data (further including audio data) captured while the camera (and the microphone) of the pair of smart glasses is activated during the session with the artificially intelligent assistant), and/or one or more other responses (e.g., the invocation confirmation 703, the response to the request 707, the camera confirmation 711, the comment on the image data 713, the first response 717, the intermediary response 721, the full response 723, the other invocation confirmation 733, the other comment on the image data 735, the third response 739, the fourth response 745, and/or the fifth response 749). The method 1078 further includes presenting the session menu UI including the session summary UI element and another session summary UI element (e.g., the first session archive UI element 805 and/or the second session UI element 810) in a chronological order, wherein the other session summary UI element includes at least one of the one or more other inputs from a user (e.g., the respective input 812a-812b), at least one of the one or more other images (e.g., the respective image 824a-824b), and/or at least one of the one or more other responses to the user (e.g., the respective response 814a-814b). The method 1078 further includes, in response to another request to view the other session information set (e.g., the select input, described in reference to FIG. 8A), presenting another session archive UI (e.g., the session archive UI 850) including the one or more other inputs from the user, the one or more other images, and/or the one or more other responses to the user in a chronological order

(Z8) In some embodiments of any of Z1-Z7, after presenting the session menu UI including the session summary UI element and the other session summary UI element in a chronological order and in response to an additional request to view the session information set, presenting the session archive UI including the one or more inputs from the user, the one or more images, and/or the one or more responses to the user in a chronological order.

(Z9) In some embodiments of any of Z1-Z8, the session menu UI includes a scrollable list of one or more session summary UI elements, including the session summary UI element, in a chronological order.

(Z10) In some embodiments of any of Z1-Z9, the one or more images include one or more still images and/or one or more video clips (e.g., the one or more playable videos, as described in reference to FIGS. 8A-8B), each video clip of the one or more video clips including a respective audio clip.

(Z11) In some embodiments of any of Z1-Z10, the method 1078 further includes while presenting the session archive UI and in response to a select input directed toward a video clip (e.g., the first video clip 841 and/or the second video clip 847) of the one or more video clips presented at the session archive UI, playing the video clip including an associated audio clip (1086).

(Z12) In some embodiments of any of Z1-Z11, the at least one of the one or more inputs from a user, the at least one of the one or more images, and/or the at least one of the one or more responses to the user included in the session summary UI element are representative of a result of the session with the artificially intelligent assistant (e.g., the most representative input of the respective extended AI assistant session, the most representative image and/or video of the respective extended AI assistant session, and/or the most representative response of the respective extended AI assistant session, as described in reference to FIG. 8A).

(Z13) In some embodiments of any of Z1-Z12, while presenting the session archive UI and in response to a return input (e.g., the return input as described in reference to FIG. 8B) 1088): (i) ceasing presenting session archive UI (1090) and (ii) presenting the session menu UI including the session summary UI element (1092).

(AA1) In accordance with some embodiments, a non-transitory, computer-readable storage medium includes executable instructions that, when executed by one or more processors, cause the one or more processors to perform or cause performance of the methods of any one of Z1-Z13.

(AB1) In accordance with some embodiments, means for performing or causing performance of the methods of any one of Z1-Z13.

(AC1) In accordance with some embodiments, a pair of smart glasses (e.g., extended reality glasses, display-less smart glasses, mixed-reality headset, etc.) is configured to perform or cause performance of the methods of any one of Z1-Z13.

(AD1) In accordance with some embodiments, an intermediary processing device (e.g., configured to offload processing operations for a head-worn device such as Augmented Reality glasses) is configured to perform or cause performance of the methods of any one of Z1-Z13.

### Example Extended-reality Systems

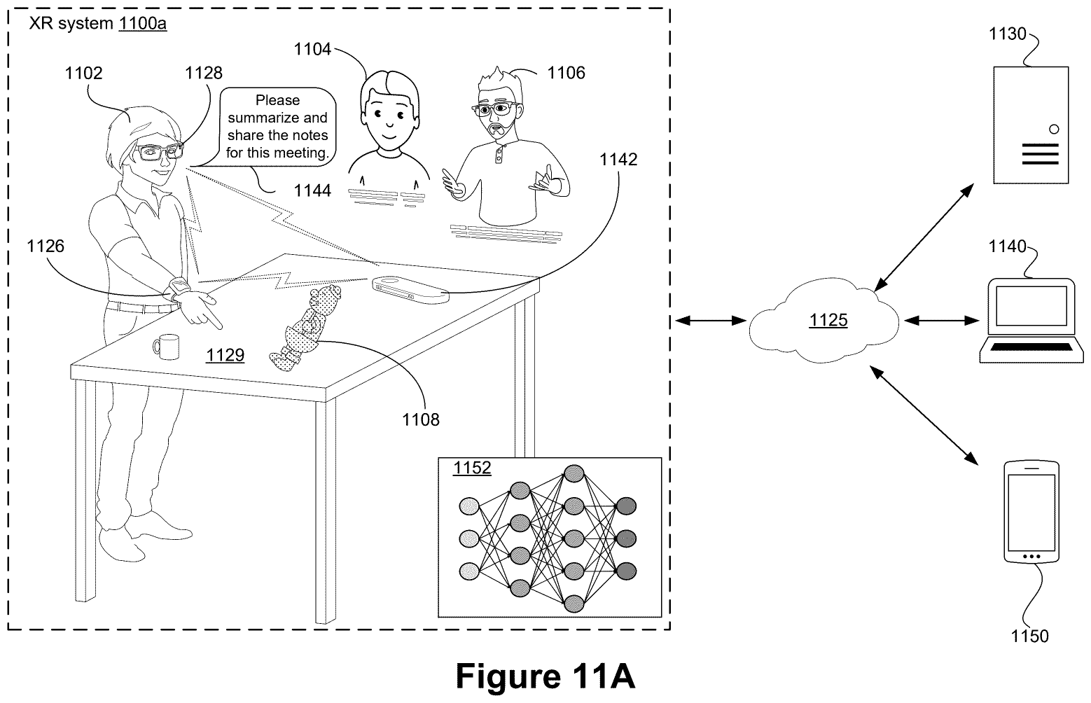

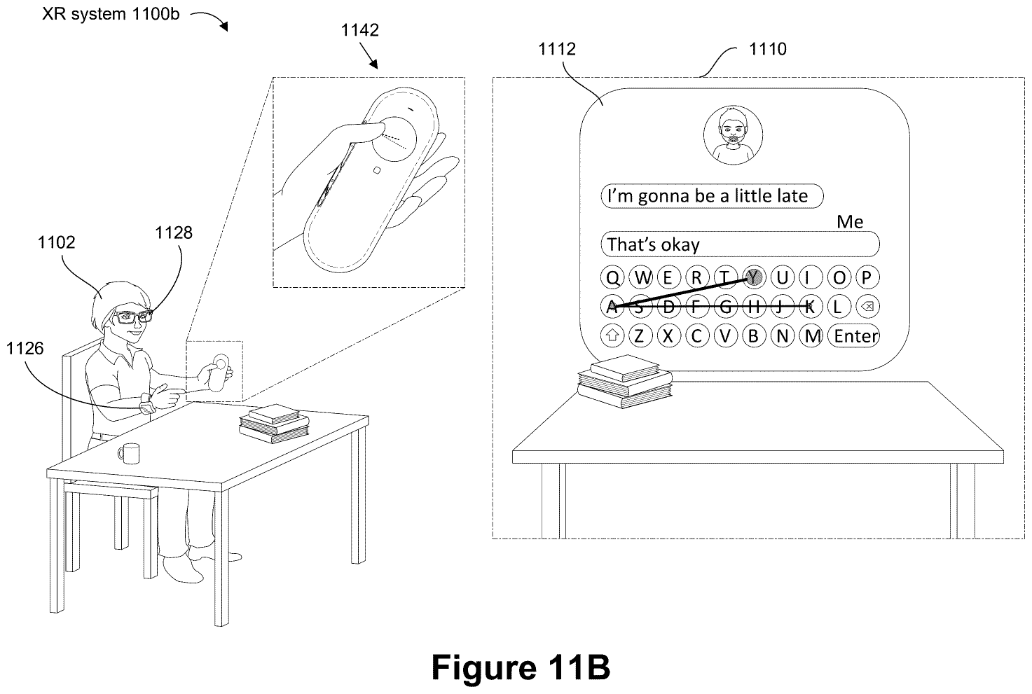

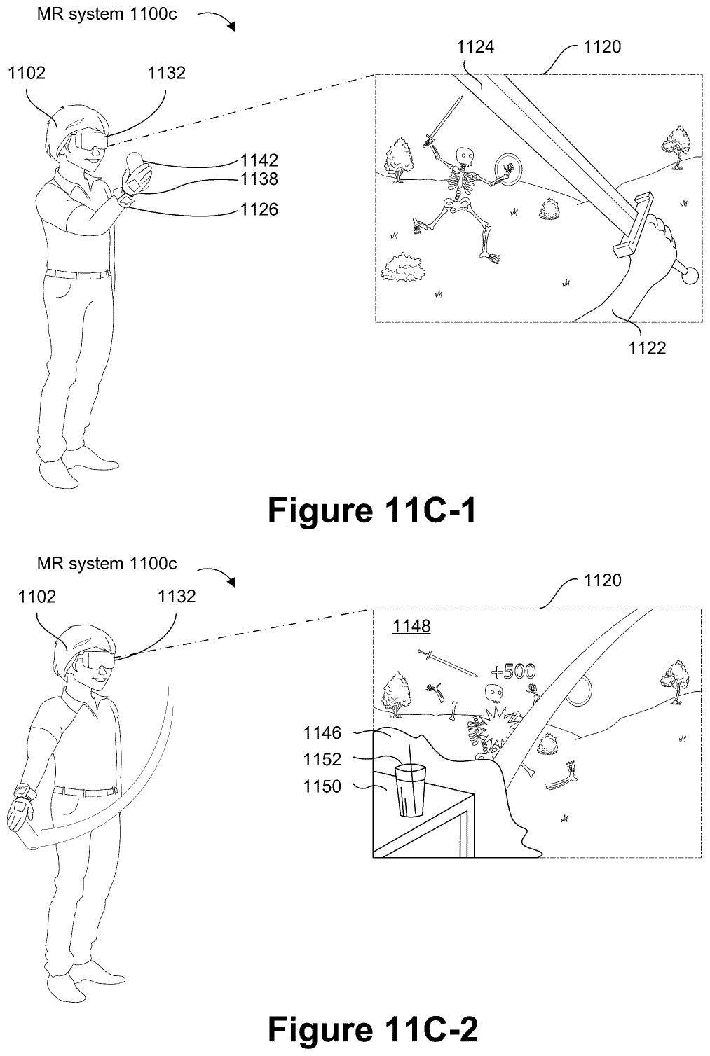

FIGS. 11A, 11B, 11C-1, and 11C-2, illustrate example XR systems that include AR and MR systems, in accordance with some embodiments. FIG. 11A shows a first XR system 1100a and first example user interactions using a wrist-wearable device 1126, a head-wearable device (e.g., AR device 1128), and/or a HIPD 1142. FIG. 11B shows a second XR system 1100b and second example user interactions using a wrist-wearable device 1126, AR device 1128, and/or an HIPD 1142. FIGS. 11C-1 and 11C-2 show a third MR system 1100c and third example user interactions using a wrist-wearable device 1126, a head-wearable device (e.g., an MR device such as a VR device), and/or an HIPD 1142. As the skilled artisan will appreciate upon reading the descriptions provided herein, the above-example AR and MR systems (described in detail below) can perform various functions and/or operations.

The wrist-wearable device 1126, the head-wearable devices, and/or the HIPD 1142 can communicatively couple via a network 1125 (e.g., cellular, near field, Wi-Fi, personal area network, wireless LAN). Additionally, the wrist-wearable device 1126, the head-wearable device, and/or the HIPD 1142 can also communicatively couple with one or more servers 1130, computers 1140 (e.g., laptops, computers), mobile devices 1150 (e.g., smartphones, tablets), and/or other electronic devices via the network 1125 (e.g., cellular, near field, Wi-Fi, personal area network, wireless LAN). Similarly, a smart textile-based garment, when used, can also communicatively couple with the wrist-wearable device 1126, the head-wearable device(s), the HIPD 1142, the one or more servers 1130, the computers 1140, the mobile devices 1150, and/or other electronic devices via the network 1125 to provide inputs.

Turning to FIG. 11A, a user 1102 is shown wearing the wrist-wearable device 1126 and the AR device 1128 and having the HIPD 1142 on their desk. The wrist-wearable device 1126, the AR device 1128, and the HIPD 1142 facilitate user interaction with an AR environment. In particular, as shown by the first AR system 1100a, the wrist-wearable device 1126, the AR device 1128, and/or the HIPD 1142 cause presentation of one or more avatars 1104, digital representations of contacts 1106, and virtual objects 1108. As discussed below, the user 1102 can interact with the one or more avatars 1104, digital representations of the contacts 1106, and virtual objects 1108 via the wrist-wearable device 1126, the AR device 1128, and/or the HIPD 1142. In addition, the user 1102 is also able to directly view physical objects in the environment, such as a physical table 1129, through transparent lens(es) and waveguide(s) of the AR device 1128. Alternatively, an MR device could be used in place of the AR device 1128 and a similar user experience can take place, but the user would not be directly viewing physical objects in the environment, such as table 1129, and would instead be presented with a virtual reconstruction of the table 1129 produced from one or more sensors of the MR device (e.g., an outward facing camera capable of recording the surrounding environment).

The user 1102 can use any of the wrist-wearable device 1126, the AR device 1128 (e.g., through physical inputs at the AR device and/or built-in motion tracking of a user's extremities), a smart-textile garment, externally mounted extremity tracking device, the HIPD 1142 to provide user inputs, etc. For example, the user 1102 can perform one or more hand gestures that are detected by the wrist-wearable device 1126 (e.g., using one or more EMG sensors and/or IMUs built into the wrist-wearable device) and/or AR device 1128 (e.g., using one or more image sensors or cameras) to provide a user input. Alternatively, or additionally, the user 1102 can provide a user input via one or more touch surfaces of the wrist-wearable device 1126, the AR device 1128, and/or the HIPD 1142, and/or voice commands captured by a microphone of the wrist-wearable device 1126, the AR device 1128, and/or the HIPD 1142. The wrist-wearable device 1126, the AR device 1128, and/or the HIPD 1142 include an artificially intelligent digital assistant to help the user in providing a user input (e.g., completing a sequence of operations, suggesting different operations or commands, providing reminders, confirming a command). For example, the digital assistant can be invoked through an input occurring at the AR device 1128 (e.g., via an input at a temple arm of the AR device 1128). In some embodiments, the user 1102 can provide a user input via one or more facial gestures and/or facial expressions. For example, cameras of the wrist-wearable device 1126, the AR device 1128, and/or the HIPD 1142 can track the user 1102's eyes for navigating a user interface.

The wrist-wearable device 1126, the AR device 1128, and/or the HIPD 1142 can operate alone or in conjunction to allow the user 1102 to interact with the AR environment. In some embodiments, the HIPD 1142 is configured to operate as a central hub or control center for the wrist-wearable device 1126, the AR device 1128, and/or another communicatively coupled device. For example, the user 1102 can provide an input to interact with the AR environment at any of the wrist-wearable device 1126, the AR device 1128, and/or the HIPD 1142, and the HIPD 1142 can identify one or more back-end and front-end tasks to cause the performance of the requested interaction and distribute instructions to cause the performance of the one or more back-end and front-end tasks at the wrist-wearable device 1126, the AR device 1128, and/or the HIPD 1142. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 1142 can perform the back-end tasks and provide the wrist-wearable device 1126 and/or the AR device 1128 operational data corresponding to the performed back-end tasks such that the wrist-wearable device 1126 and/or the AR device 1128 can perform the front-end tasks. In this way, the HIPD 1142, which has more computational resources and greater thermal headroom than the wrist-wearable device 1126 and/or the AR device 1128, performs computationally intensive tasks and reduces the computer resource utilization and/or power usage of the wrist-wearable device 1126 and/or the AR device 1128.

In the example shown by the first AR system 1100a, the HIPD 1142 identifies one or more back-end tasks and front-end tasks associated with a user request to initiate an AR video call with one or more other users (represented by the avatar 1104 and the digital representation of the contact 1106) and distributes instructions to cause the performance of the one or more back-end tasks and front-end tasks. In particular, the HIPD 1142 performs back-end tasks for processing and/or rendering image data (and other data) associated with the AR video call and provides operational data associated with the performed back-end tasks to the AR device 1128 such that the AR device 1128 performs front-end tasks for presenting the AR video call (e.g., presenting the avatar 1104 and the digital representation of the contact 1106).

In some embodiments, the HIPD 1142 can operate as a focal or anchor point for causing the presentation of information. This allows the user 1102 to be generally aware of where information is presented. For example, as shown in the first AR system 1100a, the avatar 1104 and the digital representation of the contact 1106 are presented above the HIPD 1142. In particular, the HIPD 1142 and the AR device 1128 operate in conjunction to determine a location for presenting the avatar 1104 and the digital representation of the contact 1106. In some embodiments, information can be presented within a predetermined distance from the HIPD 1142 (e.g., within five meters). For example, as shown in the first AR system 1100a, virtual object 1108 is presented on the desk some distance from the HIPD 1142. Similar to the above example, the HIPD 1142 and the AR device 1128 can operate in conjunction to determine a location for presenting the virtual object 1108. Alternatively, in some embodiments, presentation of information is not bound by the HIPD 1142. More specifically, the avatar 1104, the digital representation of the contact 1106, and the virtual object 1108 do not have to be presented within a predetermined distance of the HIPD 1142. While an AR device 1128 is described working with an HIPD, an MR headset can be interacted with in the same way as the AR device 1128.

User inputs provided at the wrist-wearable device 1126, the AR device 1128, and/or the HIPD 1142 are coordinated such that the user can use any device to initiate, continue, and/or complete an operation. For example, the user 1102 can provide a user input to the AR device 1128 to cause the AR device 1128 to present the virtual object 1108 and, while the virtual object 1108 is presented by the AR device 1128, the user 1102 can provide one or more hand gestures via the wrist-wearable device 1126 to interact and/or manipulate the virtual object 1108. While an AR device 1128 is described working with a wrist-wearable device 1126, an MR headset can be interacted with in the same way as the AR device 1128.

### Integration of Artificial Intelligence With XR Systems

FIG. 11A illustrates an interaction in which an artificially intelligent virtual assistant can assist in requests made by a user 1102. The AI virtual assistant can be used to complete open-ended requests made through natural language inputs by a user 1102. For example, in FIG. 11A the user 1102 makes an audible request 1144 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 11A also illustrates an example neural network 1152 used in Artificial Intelligence applications. Uses of Artificial Intelligence (AI) are varied and encompass many different aspects of the devices and systems described herein. AI capabilities cover a diverse range of applications and deepen interactions between the user 1102 and user devices (e.g., the AR device 1128, an MR device 1132, the HIPD 1142, the wrist-wearable device 1126). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 1102 can interact with an AI model through natural language inputs captured by a voice sensor, text inputs, or any other input modality that accepts natural language and/or a corresponding voice sensor module. In another instance, input is provided by tracking the eye gaze of a user 1102 via a gaze tracker module. Additionally, the AI model can also receive inputs beyond those supplied by a user 1102. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors'data can be retrieved entirely from a single device (e.g., AR device 1128) or from multiple devices that are in communication with each other (e.g., a system that includes at least two of an AR device 1128, an MR device 1132, the HIPD 1142, the wrist-wearable device 1126, etc.). The AI model can also access additional information (e.g., one or more servers 1130, the computers 1140, the mobile devices 1150, and/or other electronic devices) via a network 1125.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 1128, an MR device 1132, the HIPD 1142, the wrist-wearable device 1126) via the one or more networks. The cloud-computing platforms provide scalable computing resources, distributed computing, managed AI services, interference acceleration, pre-trained models, APIs, and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 1128, an MR device 1132, the HIPD 1142, the wrist-wearable device 1126), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 1142), haptic feedback can provide information to the user 1102. An AI model can also use the inputs described above to determine the appropriate modality and device(s) to present content to the user (e.g., a user walking on a busy road can be presented with an audio output instead of a visual output to avoid distracting the user 1102).

### Example Augmented Reality Interaction

FIG. 11B shows the user 1102 wearing the wrist-wearable device 1126 and the AR device 1128 and holding the HIPD 1142. In the second AR system 1100b, the wrist-wearable device 1126, the AR device 1128, and/or the HIPD 1142 are used to receive and/or provide one or more messages to a contact of the user 1102. In particular, the wrist-wearable device 1126, the AR device 1128, and/or the HIPD 1142 detect and coordinate one or more user inputs to initiate a messaging application and prepare a response to a received message via the messaging application.

In some embodiments, the user 1102 initiates, via a user input, an application on the wrist-wearable device 1126, the AR device 1128, and/or the HIPD 1142 that causes the application to initiate on at least one device. For example, in the second AR system 1100b the user 1102 performs a hand gesture associated with a command for initiating a messaging application (represented by messaging user interface 1112); the wrist-wearable device 1126 detects the hand gesture; and, based on a determination that the user 1102 is wearing the AR device 1128, causes the AR device 1128 to present a messaging user interface 1112 of the messaging application. The AR device 1128 can present the messaging user interface 1112 to the user 1102 via its display (e.g., as shown by user 1102's field of view 1110). In some embodiments, the application is initiated and can be run on the device (e.g., the wrist-wearable device 1126, the AR device 1128, and/or the HIPD 1142) that detects the user input to initiate the application, and the device provides another device operational data to cause the presentation of the messaging application. For example, the wrist-wearable device 1126 can detect the user input to initiate a messaging application, initiate and run the messaging application, and provide operational data to the AR device 1128 and/or the HIPD 1142 to cause presentation of the messaging application. Alternatively, the application can be initiated and run at a device other than the device that detected the user input. For example, the wrist-wearable device 1126 can detect the hand gesture associated with initiating the messaging application and cause the HIPD 1142 to run the messaging application and coordinate the presentation of the messaging application.

Further, the user 1102 can provide a user input provided at the wrist-wearable device 1126, the AR device 1128, and/or the HIPD 1142 to continue and/or complete an operation initiated at another device. For example, after initiating the messaging application via the wrist-wearable device 1126 and while the AR device 1128 presents the messaging user interface 1112, the user 1102 can provide an input at the HIPD 1142 to prepare a response (e.g., shown by the swipe gesture performed on the HIPD 1142). The user 1102's gestures performed on the HIPD 1142 can be provided and/or displayed on another device. For example, the user 1102's swipe gestures performed on the HIPD 1142 are displayed on a virtual keyboard of the messaging user interface 1112 displayed by the AR device 1128.

In some embodiments, the wrist-wearable device 1126, the AR device 1128, the HIPD 1142, and/or other communicatively coupled devices can present one or more notifications to the user 1102. The notification can be an indication of a new message, an incoming call, an application update, a status update, etc. The user 1102 can select the notification via the wrist-wearable device 1126, the AR device 1128, or the HIPD 1142 and cause presentation of an application or operation associated with the notification on at least one device. For example, the user 1102 can receive a notification that a message was received at the wrist-wearable device 1126, the AR device 1128, the HIPD 1142, and/or other communicatively coupled device and provide a user input at the wrist-wearable device 1126, the AR device 1128, and/or the HIPD 1142 to review the notification, and the device detecting the user input can cause an application associated with the notification to be initiated and/or presented at the wrist-wearable device 1126, the AR device 1128, and/or the HIPD 1142.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 1128 can present to the user 1102 game application data and the HIPD 1142 can use a controller to provide inputs to the game. Similarly, the user 1102 can use the wrist-wearable device 1126 to initiate a camera of the AR device 1128, and the user can use the wrist-wearable device 1126, the AR device 1128, and/or the HIPD 1142 to manipulate the image capture (e.g., zoom in or out, apply filters) and capture image data.

While an AR device 1128 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 11C-1 and 11C-2, the user 1102 is shown wearing the wrist-wearable device 1126 and an MR device 1132 (e.g., a device capable of providing either an entirely VR experience or an MR experience that displays object(s) from a physical environment at a display of the device) and holding the HIPD 1142. In the third AR system 1100c, the wrist-wearable device 1126, the MR device 1132, and/or the HIPD 1142 are used to interact within an MR environment, such as a VR game or other MR/VR application. While the MR device 1132 presents a representation of a VR game (e.g., first MR game environment 1120) to the user 1102, the wrist-wearable device 1126, the MR device 1132, and/or the HIPD 1142 detect and coordinate one or more user inputs to allow the user 1102 to interact with the VR game.

In some embodiments, the user 1102 can provide a user input via the wrist-wearable device 1126, the MR device 1132, and/or the HIPD 1142 that causes an action in a corresponding MR environment. For example, the user 1102 in the third MR system 1100c (shown in FIG. 11C-1) raises the HIPD 1142 to prepare for a swing in the first MR game environment 1120. The MR device 1132, responsive to the user 1102 raising the HIPD 1142, causes the MR representation of the user 1122 to perform a similar action (e.g., raise a virtual object, such as a virtual sword 1124). In some embodiments, each device uses respective sensor data and/or image data to detect the user input and provide an accurate representation of the user 1102's motion. For example, image sensors (e.g., SLAM cameras or other cameras) of the HIPD 1142 can be used to detect a position of the HIPD 1142 relative to the user 1102's body such that the virtual object can be positioned appropriately within the first MR game environment 1120; sensor data from the wrist-wearable device 1126 can be used to detect a velocity at which the user 1102 raises the HIPD 1142 such that the MR representation of the user 1122 and the virtual sword 1124 are synchronized with the user 1102's movements; and image sensors of the MR device 1132 can be used to represent the user 1102's body, boundary conditions, or real-world objects within the first MR game environment 1120.

In FIG. 11C-2, the user 1102 performs a downward swing while holding the HIPD 1142. The user 1102's downward swing is detected by the wrist-wearable device 1126, the MR device 1132, and/or the HIPD 1142 and a corresponding action is performed in the first MR game environment 1120. In some embodiments, the data captured by each device is used to improve the user's experience within the MR environment. For example, sensor data of the wrist-wearable device 1126 can be used to determine a speed and/or force at which the downward swing is performed and image sensors of the HIPD 1142 and/or the MR device 1132 can be used to determine a location of the swing and how it should be represented in the first MR game environment 1120, which, in turn, can be used as inputs for the MR environment (e.g., game mechanics, which can use detected speed, force, locations, and/or aspects of the user 1102's actions to classify a user's inputs (e.g., user performs a light strike, hard strike, critical strike, glancing strike, miss) or calculate an output (e.g., amount of damage)).

FIG. 11C-2 further illustrates that a portion of the physical environment is reconstructed and displayed at a display of the MR device 1132 while the MR game environment 1120 is being displayed. In this instance, a reconstruction of the physical environment 1146 is displayed in place of a portion of the MR game environment 1120 when object(s) in the physical environment are potentially in the path of the user (e.g., a collision with the user and an object in the physical environment are likely). Thus, this example MR game environment 1120 includes (i) an immersive VR portion 1148 (e.g., an environment that does not have a corollary counterpart in a nearby physical environment) and (ii) a reconstruction of the physical environment 1146 (e.g., table 1150 and cup 1152). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 1126, the MR device 1132, and/or the HIPD 1142 are described as detecting user inputs, in some embodiments, user inputs are detected at a single device (with the single device being responsible for distributing signals to the other devices for performing the user input). For example, the HIPD 1142 can operate an application for generating the first MR game environment 1120 and provide the MR device 1132 with corresponding data for causing the presentation of the first MR game environment 1120, as well as detect the user 1102's movements (while holding the HIPD 1142) to cause the performance of corresponding actions within the first MR game environment 1120. Additionally or alternatively, in some embodiments, operational data (e.g., sensor data, image data, application data, device data, and/or other data) of one or more devices is provided to a single device (e.g., the HIPD 1142) to process the operational data and cause respective devices to perform an action associated with processed operational data.

In some embodiments, the user 1102 can wear a wrist-wearable device 1126, wear an MR device 1132, wear smart textile-based garments 1138 (e.g., wearable haptic gloves), and/or hold an HIPD 1142 device. In this embodiment, the wrist-wearable device 1126, the MR device 1132, and/or the smart textile-based garments 1138 are used to interact within an MR environment (e.g., any AR or MR system described above in reference to FIG. 11A-11B). While the MR device 1132 presents a representation of an MR game (e.g., second MR game environment 1120) to the user 1102, the wrist-wearable device 1126, the MR device 1132, and/or the smart textile-based garments 1138 detect and coordinate one or more user inputs to allow the user 1102 to interact with the MR environment.

In some embodiments, the user 1102 can provide a user input via the wrist-wearable device 1126, an HIPD 1142, the MR device 1132, and/or the smart textile-based garments 1138 that causes an action in a corresponding MR environment. In some embodiments, each device uses respective sensor data and/or image data to detect the user input and provide an accurate representation of the user 1102's motion. While four different input devices are shown (e.g., a wrist-wearable device 1126, an MR device 1132, an HIPD 1142, and a smart textile-based garment 1138) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 1138) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 1138 can be used in conjunction with an MR device and/or an HIPD 1142.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
cause invocation of an artificially intelligent assistant at a pair of smart glasses without providing a query, wherein the artificially intelligent assistant has access to camera data provided by a camera of the pair of smart glasses;
in response to the invocation of the artificially intelligent assistant at the pair of smart glasses:
determine, based in part on the camera data, that the artificially intelligent assistant should provide assistance to a user related to an object present within the camera data; and
in response to the determining, cause a communication that includes the assistance to the user related to the object present within the camera data to be provided to the user via an output modality of the pair of smart glasses.

2. The non-transitory, computer-readable storage medium of claim 1, wherein the executable instructions further cause the one or more processors to:
in accordance with a determination that a response is received to the communication, cause a further communication that is based on the response to be provided to the user; and
in accordance with a determination that a response is not received to the communication, cause a further communication indicating that the artificially intelligent assistant remains active to be provided to the user.

3. The non-transitory, computer-readable storage medium of claim 1, wherein the communication is based on a predicted intent of the user.

4. The non-transitory, computer-readable storage medium of claim 1, wherein the invocation of the artificially intelligent assistant is in response to a gesture captured at the pair of smart glasses.

5. The non-transitory, computer-readable storage medium of claim 1, wherein the invocation of the artificially intelligent assistant is in response to the pair of smart glasses detecting a wake word for invoking the artificially intelligent assistant.

6. The non-transitory, computer-readable storage medium of claim 1, wherein the invocation of the artificially intelligent assistant includes an open-ended query provided by the user.

7. The non-transitory, computer-readable storage medium of claim 1, wherein the executable instructions further cause the one or more processors to:
in response to the invocation of the artificially intelligent assistant and before causing the communication that includes the assistance to the user related to the object present within the camera data to be provided to the user, cause a confirmation that the artificially intelligent assistant has been invoked to be provided to the user.

8. The non-transitory, computer-readable storage medium of claim 1, wherein the executable instructions further cause the one or more processors to:
after causing the communication that includes the assistance to the user related to the object present within the camera data to be provided to the user, obtain another communication from the user that indicates that the user is done interacting with the artificially intelligent assistant; and
in response to receiving the other communication, cease use of the artificially intelligent assistant.

9. The non-transitory, computer-readable storage medium of claim 8, wherein the executable instructions further cause the one or more processors to:
in response to ceasing use of the artificially intelligent assistant, cause a confirmation that the artificially intelligent assistant is no longer in use to be provided to the user.

10. The non-transitory, computer-readable storage medium of claim 1, wherein the communication to the user is generated based in part on providing information about the object present within the camera data to a large language model.

11. The non-transitory, computer-readable storage medium of claim 1, wherein the communication to the user is further based on additional sensor data from sensors different from the camera.

12. The non-transitory, computer-readable storage medium of claim 1, wherein the executable instructions further cause the one or more processors to:
further in response to the invocation of the artificially intelligent assistant at the pair of smart glasses:
determine, based in part on the camera data, that the artificially intelligent assistant should provide assistance to the user related to an additional object, distinct form the object, present within the camera data; and
in response to the determining, cause an additional communication to the user that includes the assistance to the user related to the additional object present within the camera data to be provided to the user via the output modality of the pair of smart glasses.

13. The non-transitory, computer-readable storage medium of claim 1, wherein the communication to the user also includes an extended-reality augment presented at a display of the smart glasses.

14. A method comprising:
invoking an artificially intelligent assistant at a pair of smart glasses without providing a query, wherein the artificially intelligent assistant has access to camera data provided by a camera of the pair of smart glasses;
in response to invoking the artificially intelligent assistant at the pair of smart glasses:
determining, based in part on the camera data, that the artificially intelligent assistant should provide assistance to a user related to an object present within the camera data; and
in response to the determining, providing, via an output modality of the pair of smart glasses, a communication to the user that includes the assistance to the user related to the object present within the camera data.

15. The method of claim 14, further comprising:
in accordance with a determination that a response is received to the communication, providing a further communication that is based on the response to the user; and
in accordance with a determination that a response is not received to the communication, providing a further communication indicating that the artificially intelligent assistant remains active to the user.

16. The method of claim 14, further comprising:
further in response to invoking the artificially intelligent assistant at the pair of smart glasses:
determining, based in part on the camera data, that the artificially intelligent assistant should provide assistance to the user related to an additional object, distinct form the object, present within the camera data; and
in response to the determining, providing, via the output modality of the pair of smart glasses, an additional communication to the user that includes the assistance to the user related to the additional object present within the camera data to the user.

17. The method of claim 14, wherein the invoking of the artificially intelligent assistant includes an open-ended query provided by the user.

18. A head-wearable device including a camera and one or more output modalities, the head-wearable device configured to:
cause invocation of an artificially intelligent assistant at head-wearable device without providing a query, wherein the artificially intelligent assistant has access to camera data provided by the camera;
in response to the invocation of the artificially intelligent assistant at the head-wearable device:
determine, based in part on the camera data, that the artificially intelligent assistant should provide assistance to a user related to an object present within the camera data; and
in response to the determining, cause a communication that includes the assistance to the user related to the object present within the camera data to be provided to the user via an output modality of the one or more output modalities.

19. The head-wearable device of claim 18, wherein the head-wearable device is further configured to:
in accordance with a determination that a response is received to the communication, cause a further communication that is based on the response to be provided to the user; and
in accordance with a determination that a response is not received to the communication, cause a further communication indicating that the artificially intelligent assistant remains active to be provided to the user.

20. The head-wearable device of claim 19, wherein the head-wearable device is further configured to:
further in response to the invocation of the artificially intelligent assistant at the head-wearable device:
determine, based in part on the camera data, that the artificially intelligent assistant should provide assistance to the user related to an additional object, distinct form the object, present within the camera data; and
in response to the determining, cause an additional communication to the user that includes the assistance to the user related to the additional object present within the camera data to be provided to the user via the output modality of the head-wearable device.
